(19) United States
(12) Patent Application Publication
(10) Pub. No.: US 2025/0108632 A1
(43) Pub. Date: Apr. 3, 2025

(54) DRYING DEVICE, DRYING CONTROL METHOD, AND NON-TRANSITORY COMPUTER-READABLE MEDIUM STORING COMPUTER-READABLE INSTRUCTIONS

(71) Applicant: BROTHER KOGYO KABUSHIKI KAISHA, Nagoya (JP)

(72) Inventors: Takuro YAMAZAKI, Anjo (JP); Daisuke KAWASE, Konan (JP); Shuichi TAMAKI, Nagoya (JP); Tetsuro KOBAYASHI, Nagoya (JP)

(21) Appl. No.: 18/898,095

(22) Filed: Sep. 26, 2024

(30) Foreign Application Priority Data
Sep. 28, 2023 (JP) 2023-166794

(51) Int. Cl. B41J 11/00; B41J 11/06; B41J 11/14; B41J 11/20

(52) U.S. Cl. CPC B41J 11/00222; B41J 11/00224; B41J 11/06; B41J 11/14; B41J 11/20

(57) ABSTRACT

A drying device includes a housing, a heater, a fan, and a processor. The housing includes an internal space housing a platen and an opening connected to the internal space and being of a size through which the platen passes. A medium to which an ink or a treatment liquid is applied is placed on the platen. The fan supplies heated air to the internal space. In a housed state of the platen housed in the internal space, the processor switches an air supply state of the heated air supplied by the fan from a first air supply state to a second air supply state different from the first air supply state by controlling at least one of the heater or the fan.

### REFERENCE TO RELATED APPLICATIONS

This application claims priority from Japanese Patent Application No. 2023-166794 filed on Sep. 28, 2023. The entire content of the priority application is incorporated herein by reference.

### BACKGROUND ART

In order to improve fixing, to a medium, of an ink applied to the medium by a printer, a drying device is known that dries the medium to which the ink or a treatment liquid has been applied. For example, a heating device heats, in a non-contact manner, a medium placed on a tray and to which ink has been applied.

### SUMMARY

In the above-described heating device, it is conceivable to dry the medium by supplying heated air, using a fan, to an internal space for housing the tray on which the medium is placed, for example. In this case, in the heating device, an opening is provided, of a size through which not only the medium but also the tray can enter from the outside of the heating device to the internal space. Thus, the heated air can easily escape from the internal space to the outside of the heating device, via the opening of this size. As a result, it is difficult to adjust the temperature of the air in the internal space in the heating device and to adjust an air supply state, such as an air flow amount and the like, by the fan. It is thus difficult to adjust a heated state of the medium.

Embodiments of the broad principles derived herein provide a drying device, a drying control method, and a non-transitory computer-readable medium storing computer-readable instructions that contribute to adjusting a heated state of a medium.

A first aspect of the present disclosure relates to a drying device. The drying device includes a housing including an internal space and an opening. The internal space is configured to house a platen. A medium to which an ink or a treatment liquid is applied is configured to be placed on the platen. The opening is connected to the internal space and is of a size through which the platen passes. The drying device includes a heater configured to heat air. The drying device includes a fan configured to supply heated air to the internal space. The heated air is air heated by the heater. The drying device includes a processor. The drying device includes a memory storing computer-readable instructions that, when executed by the processor, instruct the processor to perform a process. The process includes switching, in a housed state of the platen being housed in the internal space, an air supply state of the heated air supplied by the fan from a first air supply state to a second air supply state different from the first air supply state by controlling at least one of the heater or the fan.

According to the first aspect, the processor adjusts the air supply state of the heated air, in the housed state, by switching the air supply state of the heated air from the first air supply state to the second air supply state. Thus, the drying device contributes to adjusting a heated state of the medium.

A second aspect of the present disclosure relates to a drying control method. The drying control method includes a switching processing of switching an air supply state of heated air from a first air supply state to a second air supply state different from the first air supply state by controlling at least one of a heater or a fan in a housed state of a platen being housed in a internal space. A medium to which an ink or a treatment liquid is applied is configured to be placed on the platen. The internal space is a space provided inside a housing and is connected to an opening. The opening is provided at the housing and being of a size through which the platen passes. The heater is configured to heat air. The heated air is air heated by the heater. The fan is configured to supply the heated air to the internal space. The second aspect contributes to adjusting a heated state of the medium in the same way as the first aspect.

A third aspect of the present disclosure relates to a non-transitory computer-readable medium storing computer-readable instructions. The computer-readable instructions, when executed by a computer, instruct the computer to perform a process. The process includes a switching processing of switching an air supply state of heated air from a first air supply state to a second air supply state different from the first air supply state by controlling at least one of a heater or a fan in a housed state of a platen being housed in a internal space. A medium to which an ink or a treatment liquid is applied is configured to be placed on the platen. The internal space is a space provided inside a housing and is connected to an opening. The opening is provided at the housing and being of a size through which the platen passes. The heater is configured to heat air. The heated air is air heated by the heater. The fan is configured to supply the heated air to the internal space. The third aspect contributes to adjusting a heated state of the medium in the same way as the first aspect.

### BRIEF DESCRIPTION OF DRAWINGS

FIG. 1 is a plan view schematically showing a print system.

FIG. 2 is a perspective view of a platen.

FIG. 3 is a schematic view of an interior of a first drying device as seen from the front.

FIG. 4 is a block diagram showing an electrical configuration of the first drying device.

FIG. 5 is a flowchart of first drying control processing.

FIG. 6 is a flowchart of the first drying control processing and is a continuation of FIG. 5.

FIG. 7 is a view showing a first setting table.

FIG. 8 is a view showing respective relationships, when an entire application is performed, between an elapsed time period, a target air flow amount, and a target temperature.

FIG. 9 is a view showing a second setting table.

FIG. 10 is a view showing respective relationships, when a partial application is performed, between the elapsed time period, the target air flow amount, and the target temperature.

FIG. 11 is a view of an air blowing chamber provided with louvers.

### DESCRIPTION

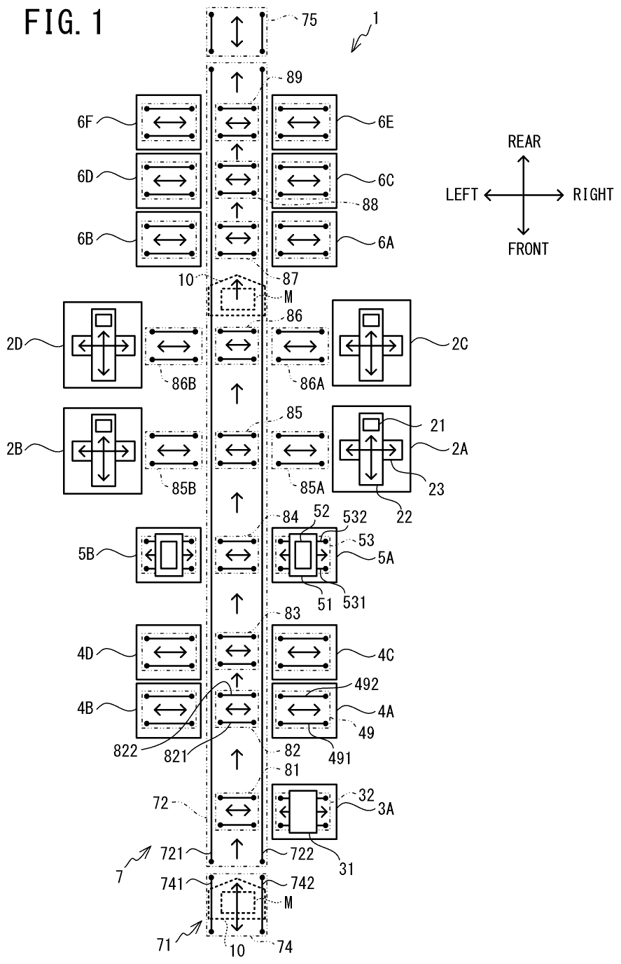

A print system 1 according to an embodiment of the present disclosure will be described with reference to the drawings. The print system 1 shown in FIG. 1, is a system that, while conveying a plurality of platens 10, sequentially performs pre-treatment processing, print processing, and post-treatment processing, in the order of the pre-treatment processing, the print processing, and the post-treatment processing, on media M respectively placed on the plurality of platens 10. In the pre-treatment processing according to the present embodiment, application processing, first drying processing, and heat press processing are performed in the order of the application processing, the first drying processing, and the heat press processing. In the post-treatment processing according to the present embodiment, second drying processing is performed. Each of the processing steps will be described in detail below.

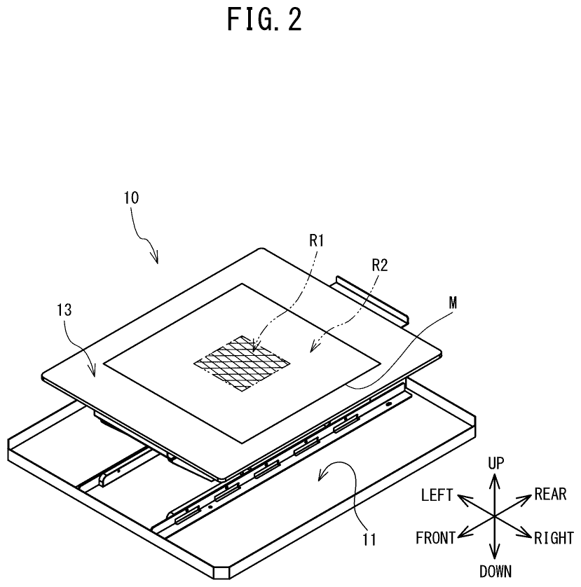

The configuration of the print system 1 will be described with reference to FIG. 1 and FIG. 2. In FIG. 1, the upward direction, the downward direction, the leftward direction, the rightward direction, a depth direction on paper, and a front direction on paper are, respectively, a rearward direction, a forward direction, a leftward direction, a rightward direction, a downward direction, and an upward direction of the print system 1. As shown in FIG. 1, the print system 1 is provided with a plurality of printers 2A, 2B, 2C, and 2D, an application device 3A, a plurality of first drying devices 4A, 4B, 4C, and 4D, a plurality of heat press devices 5A and 5B, a plurality of second drying devices 6A, 6B, 6C, 6D, 6E, and 6F, a conveyance device 7, and the platens 10.

Each of the plurality of printers 2A, 2B, 2C, and 2D is a device that performs the print processing. The print processing is processing to apply a liquid ink to the medium M, and perform printing of an image. In the present embodiment, each of the printers 2A, 2B, 2C, and 2D is an inkjet printer, and performs the printing on a cloth, paper, or the like, as the medium M.

The printer 2A is disposed further to the right than a main path 71 to be described below. For example, a surface in which an entry port for the platen 10 into each of the printers 2A, 2B, 2C, and 2D is provided is a front surface. In this case, the left surface of the printer 2A is the front surface of the printer 2A. The printer 2B is disposed to the left of the printer 2A. The front surface of the printer 2B faces the front surface of the printer 2A, with the main path 71 interposed therebetween. The printer 2C is disposed to the rear of the printer 2A. The front surface of the printer 2C is oriented in the same direction as the front surface of the printer 2A. The printer 2D is disposed to the left of the printer 2C. The front surface of the printer 2D faces the front surface of the printer 2C, with the main path 71 interposed therebetween.

The printers 2B, 2C and 2D have the same structure as that of the printer 2A. Thus, hereinafter, the structure of the printer 2A will be described, and a description of the structure of the printers 2B, 2C, and 2D will be omitted. The printer 2A is provided with an inkjet head 21, a main scanning conveyance mechanism 22, and a sub-scanning conveyance mechanism 23. The inkjet head 21 includes nozzles (not shown in the drawings). The inkjet head 21 discharges ink from the nozzles as a result of being driven by head drive elements (not shown in the drawings). The colors of the ink are, for example, white (W), black (K), yellow (Y), cyan (C), and magenta (M).

The main scanning conveyance mechanism 22 conveys the inkjet head 21 in the main scanning direction by driving of a main scanning motor (not shown in the drawings). In the printer 2A, the main scanning direction is the front-rear direction. The sub-scanning conveyance mechanism 23 conveys the platen 10 in the sub-scanning direction by driving of a sub-scanning motor (not shown in the drawings). In the printer 2A, the sub-scanning direction is the left-right direction.

The printer 2A controls the main scanning conveyance mechanism 22 and the sub-scanning conveyance mechanism 23, and moves the medium M relative to the inkjet head 21 in the main scanning direction and the sub-scanning direction. The printer 2A controls the inkjet head 21 and discharges the ink from the nozzles, while moving the medium M relative to the inkjet head 21. In this way, the print processing is performed in which the ink is applied to the medium M, and the image is printed on the medium M.

The application device 3A is a device that performs application processing. The application processing is performed before the print processing. The application processing is processing to apply a treatment liquid to the medium M. The treatment liquid is a base coat agent, and is, for example, an aqueous solution containing a cationic polymer or a polyvalent metal salt. The polyvalent metal salt is, for example, calcium chloride, or calcium nitrate. The treatment liquid improves fixing of the ink to the medium M and improves the color development of the ink.

The application device 3A is disposed further to the right than the main path 71, at a position further to the front than the printer 2A. For example, a surface in which the entry port for the platen 10 is provided is the front surface of the application device 3A. In this case, the left surface of the application device 3A is the front surface of the application device 3A. The application device 3A is provided with an application portion 31, and a conveyance path 32. The application portion 31 is a spray in the present embodiment, and sprays the treatment liquid. Note that the application portion 31 may be a discharge head, an application spatula, or the like.

The conveyance path 32 branches from the main path 71 to be described later, and extends to the application device 3A. The conveyance path 32 conveys the platen 10 in the left-right direction by driving of a conveyance motor (not shown in the drawings) of the conveyance path 32. The conveyance path 32 has the same structure as a conveyance path 49 to be described later. Thus, a description of the structure of the conveyance path 32 will be omitted here. In the application device 3A, in a state in which the platen 10 has been disposed directly below the application portion 31 by the conveyance path 32, the application portion 31 sprays the treatment liquid onto the medium M on the platen 10. In this way, the application processing in which the treatment liquid is applied to the medium M is performed.

Each of the plurality of first drying devices 4A, 4B, 4C, and 4D is a device that performs first drying processing. The first drying processing is performed after the application processing, and before the print processing. The first drying processing is processing to evaporate moisture content of the treatment liquid applied to the medium M by the application processing, by drying the medium M using a high temperature atmosphere. In this way, the fixing of solute in the treatment liquid to the medium M is improved.

The first drying devices 4A, 4B, 4C, and 4D are disposed, in the front-rear direction, between the printers 2A and 2B, and the application device 3A. Positional relationships of each of the first drying devices 4A, 4B, 4C, and 4D are the same as the positional relationships of each of the printers 2A, 2B, 2C, and 2D.

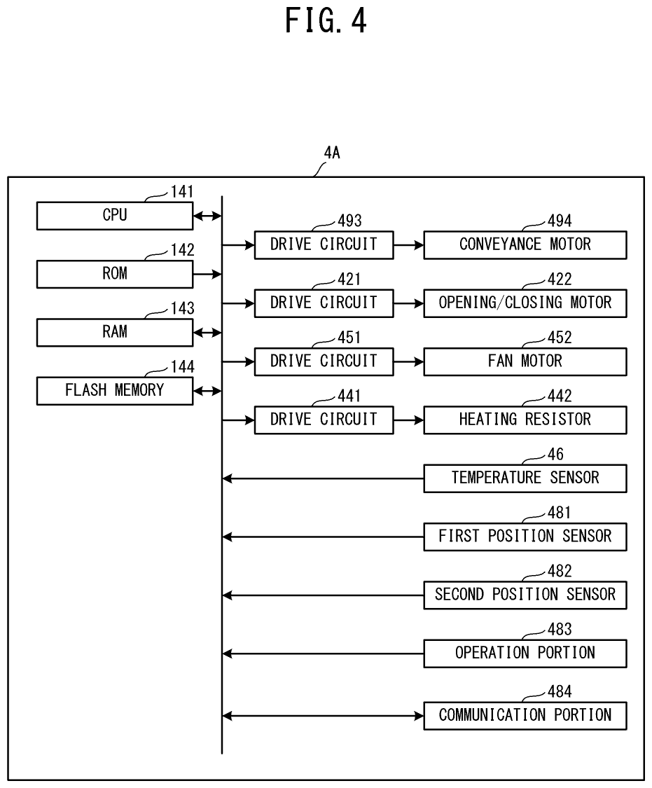

The plurality of first drying devices 4A, 4B, 4C, and 4D have the same structure as each other. Thus, the structure of the first drying device 4A will be described as an example, and a description of the plurality of first drying devices 4A, 4B, 4C, and 4D will be omitted. The first drying device 4A is provided with the conveyance path 49. The conveyance path 49 branches to the right from the main path 71 to be described later, and extends to the first drying device 4A. The conveyance path 49 conveys the platen 10 in the left-right direction by driving of a conveyance motor 494 shown in FIG. 4. Thus, a conveyance direction of the conveyance path 49 is the left-right direction.

In the present embodiment, the conveyance path 49 is configured by a pair of belt conveyors 491 and 492. The belt conveyor 491 is disposed at the front end of the conveyance path 49. The belt conveyor 492 is disposed at the rear end of the conveyance path 49. The pair of belt conveyors 491 and 492 extend in the left-right direction in parallel with each other. Rotation shafts of each of the pair of belt conveyors 491 and 492 extend in the front-rear direction. A detailed structure of the first drying device 4A will be described later.

Each of the plurality of heat press devices 5A and 5B is a device that performs heat press processing. The heat press processing is performed after the first drying processing, and before the print processing. The heat press processing is processing to evaporate the moisture content of the treatment liquid remaining in the medium M in the first drying processing, by applying pressure to the medium M using a high temperature. In this way, the fixing of the solute in the treatment liquid to the medium M is improved. Furthermore, the heat press processing is processing to smooth out a print surface of the medium M in a flat surface shape, by flattening fluff on the print surface of the medium M. In this way, print quality on the medium M by the printers 2A, 2B, 2C, and 2D is improved.

The heat press devices 5A and 5B are disposed, in the front-rear direction, between the printers 2A and 2B, and the first drying devices 4C and 4D. The positional relationship of the heat press devices 5A and 5B is the same as the positional relationship of the printers 2A and 2B.

The heat press device 5B has the same structure as that of the heat press device 5A. Thus, hereinafter, the structure of the heat press device 5A will be described and a description of the structure of the heat press device 5B will be omitted. The heat press device 5A is provided with a press portion 51, a heating portion 52, and a conveyance path 53. The press portion 51 moves in the up-down direction by driving of a press motor (not shown in the drawings). The press portion 51 presses the medium M against an attachment plate 13 (refer to FIG. 2) to be described later, by moving downward. The heating portion 52 heats the press portion 51.

The conveyance path 53 branches to the right from the main path 71 to be described later, and extends to the heat press device 5A. The conveyance path 53 conveys the platen 10 in the left-right direction by driving of a conveyance motor (not shown in the drawings) of the conveyance path 53. The structure of the conveyance path 53 is the same as that of the conveyance path 49. Thus, a description of the structure of the conveyance path 53 will be omitted. In the heat press device 5A, in a state in which the platen 10 has been disposed directly below the press portion 51 by the conveyance path 53, the press portion 51 heated by the heating portion 52 presses the medium M. In this way, the heat press processing is performed in which the medium M is pressed using the high temperature.

Each of the plurality of second drying devices 6A, 6B, 6C, 6D, 6E, and 6F is a device that performs second drying processing. The second drying processing is performed after the print processing. The second drying processing is processing to evaporate moisture content in the ink applied to the medium M by the print processing, by drying the medium M using a high temperature atmosphere. In this way, the fixing of pigment or dye in the ink to the medium M is improved.

The plurality of second drying devices 6A, 6B, 6C, 6D, 6E, and 6F are disposed further to the rear than the printers 2C and 2D. The positional relationships of each of the plurality of second drying devices 6A, 6B, 6C, and 6D are the same as the positional relationships of each of the plurality of printers 2A, 2B, 2C, and 2D. Furthermore, the plurality of second drying devices 6E and 6F are arranged in the left-right direction with the main path 71 interposed therebetween, and are disposed to the rear of the plurality of second drying devices 6C and 6D. Each of the plurality of second drying devices 6A, 6B, 6C, 6D, 6E, and 6F has the same structure as that of the first drying device 4A. Thus, a description of the structure of the plurality of second drying devices 6A, 6B, 6C, 6D, 6E, and 6F will be omitted.

The conveyance device 7 conveys the platen 10 such that the application processing, the first drying processing, the heat press processing, the print processing, and the second drying processing are sequentially performed. The conveyance device 7 is provided with the main path 71 and transfer mechanisms 81 to 89. The main path 71 has a two-level structure, and is provided with an outward path 72, a return path (not shown in the drawings), and elevator mechanisms 74 and 75. The outward path 72 is a second level portion, and extends in the front-rear direction from a position further to the front than the application device 3A to a position further to the rear than the second drying devices 6E and 6F. The return path is a first level portion, and extends in the front-rear direction from a position further to the front than the application device 3A to a position further to the rear than the second drying devices 6E and 6F. In other words, the return path is disposed directly below the outward path 72, and extends in parallel to the outward path 72.

The outward path 72 conveys the platen 10 from the front toward the rear by driving of a conveyance motor (not shown in the drawings) of the outward path 72. In the present embodiment, the outward path 72 is configured by a pair of belt conveyors 721 and 722. The belt conveyor 721 is disposed at the left end of the outward path 72. The belt conveyor 722 is disposed at the right end of the outward path 72. The pair of belt conveyors 721 and 722 extend in the front-rear direction in parallel to each other. Rotation shafts of each of the pair of belt conveyors 721 and 722 extend in the left-right direction. The return path has the same structure as that of the outward path 72, and conveys the platen 10 from the rear toward the front by driving of a conveyance motor (not shown in the drawings) of the return path.

The elevator mechanism 74 is disposed at the front end of the main path 71. The elevator mechanism 75 is disposed at the rear end of the main path 71. Thus, the outward path 72 and the return path are disposed between the elevator mechanism 74 and the elevator mechanism 75 in the front-rear direction. The elevator mechanisms 74 and 75 move up and down, by driving of respective lifting motors (not shown in the drawings), to a position at the same height as the outward path 72 (the second level portion) and a position at the same height as the return path (the first level portion). Furthermore, the elevator mechanisms 74 and 75 convey the platen 10 in the front-rear direction by driving of respective conveyance motors (not shown in the drawings).

In the present embodiment, the elevator mechanism 74 is configured by a pair of belt conveyors 741 and 742. The belt conveyor 741 is disposed at the left end of the elevator mechanism 74. The belt conveyor 742 is disposed at the right end of the elevator mechanism 74. The pair of belt conveyors 741 and 742 extend in the front-rear direction in parallel to each other. Rotation shafts of each of the pair of belt conveyors 741 and 742 extend in the left-right direction. The elevator mechanism 75 has the same structure as that of the elevator mechanism 74. Thus, a description of the structure of the elevator mechanism 75 will be omitted.

The transfer mechanisms 81 to 89 are disposed between the pair of belt conveyors 721 and 722 in the left-right direction. The transfer mechanisms 81 to 89 are arranged in the order of the transfer mechanisms 81, 82, 83, 84, 85, 86, 87, 88, and 89, from the front to the rear, in the outward path 72. Each of the transfer mechanisms 81 to 89 conveys the platen 10 in the left-right direction, and transfers the platen 10 between the outward path 72 and a conveyance mechanism of each of the devices adjacent to the outward path 72. For example, the transfer mechanism 81 transfers the platen 10 between the outward path 72 and the conveyance path 32 of the application device 3A. The transfer mechanism 82 transfers the platen 10 between the outward path 72 and the conveyance path 49 of the first drying device 4A. Furthermore, the transfer mechanism 82 transfers the platen 10 between the outward path 72 and a conveyance path (not shown in the drawings) of the first drying device 4B.

The transfer mechanism 84 transfers the platen 10 between the outward path 72 and the conveyance path 53 of the heat press device 5A. Furthermore, the transfer mechanism 84 transfers the platen 10 between the outward path 72 and a conveyance path (not shown in the drawings) of the heat press device 5B. The transfer mechanism 85 transfers the platen 10 between the outward path 72 and the sub-scanning conveyance mechanism 23 of the printer 2A, via a connecting conveyance path 85A. Furthermore, the transfer mechanism 85 transfers the platen 10 between the outward path 72 and a sub-scanning conveyance mechanism (not shown in the drawings) of the printer 2B, via a connecting conveyance path 85B. The transfer mechanism 86 transfers the platen 10 between the outward path 72 and a sub-scanning conveyance mechanism (not shown in the drawings) of the printer 2C, via a connecting conveyance path 86A. Furthermore, the transfer mechanism 86 transfers the platen 10 between the outward path 72 and a sub-scanning conveyance mechanism (not shown in the drawings) of the printer 2D, via a connecting conveyance path 86B.

The transfer mechanisms 81, and 83 to 89 each have the same structure as that of the transfer mechanism 82. Thus, hereinafter, the structure of the transfer mechanism 82 will be described, and a description of the structure of the transfer mechanisms 81, and 83 to 89 will be omitted. In the present embodiment, the transfer mechanism 82 moves up and down between a position lower than the outward path 72 and a position higher than the outward path 72, by driving of a lifting motor (not shown in the drawings) of the transfer mechanism 82. Furthermore, by driving of a rotation motor (not shown in the drawings), the transfer mechanism 82 rotates the platen 10 on the transfer mechanism 82 in the clockwise direction or the counterclockwise direction in a plan view. When the medium M is a T-shirt, for example, the transfer mechanism 82 switches an orientation of the platen 10 such that the neckline of the T-shirt is oriented in an advancing direction of the platen 10.

In the present embodiment, the transfer mechanism 82 is configured by a pair of belt conveyors 821 and 822. The belt conveyor 821 is disposed at the front end of the transfer mechanism 82. The belt conveyor 822 is disposed at the rear end of the transfer mechanism 82. The pair of belt conveyors 821 and 822 extend in the left-right direction in parallel to each other. Rotation shafts of each of the pair of belt conveyors 821 and 822 extend in the front-rear direction.

In FIG. 2, the upward direction, the downward direction, the upper left direction, the lower right direction, the lower left direction, and the upper right direction are, respectively, the upward direction, the downward direction, the leftward direction, the rightward direction, the forward direction, and the rearward direction of the platen 10. As shown in FIG. 2, the platen 10 is provided with a tray 11, a support base 12, and the attachment plate 13. The tray 11 has a rectangular shape in a plan view, and receives a drooping portion of the medium M attached to the attachment plate 13, for example. The support base 12 extends upward from the upper surface of the tray 11.

The attachment plate 13 is mounted to the support base 12, and has a rectangular shape in a plan view. The medium M is placed on the attachment plate 13. In the present embodiment, the medium M placed on the attachment plate 13 is also referred to as “the medium M on the platen 10”. The size of the attachment plate 13 is not limited to a particular size, and the length thereof in the left-right direction is approximately 40 cm and the length thereof in the front-rear direction is approximately 40 cm, for example. The height in the up-down direction of the entire platen 10 is not limited to a particular magnitude, and is approximately 30 cm, for example.

A print region R1 and a non-print region R2 will be defined. The print region R1 is a region, of the medium M in a plan view, surrounded by an outer shape of the image to be printed by the print processing. When the outer shape of the image is rectangular, for example, the print region R1 has a rectangular shape. The non-print region R2 is a region on the outside of the print region R1, of the medium M in a plan view.

A flow of operations by the print system 1 will be described with reference to FIG. 1. Hereinafter, for convenience, it is assumed that, at the start of the operations by the print system 1, each of the transfer mechanisms 81 to 89 is disposed lower than the outward path 72, and each of the elevator mechanisms 74 and 75 is disposed at the same height as the outward path 72.

In a state in which the platen 10 is disposed on the elevator mechanism 74, the rearward direction of the platen 10 shown in FIG. 2 is oriented in the rearward direction of the print system 1 shown in FIG. 1. A user attaches the medium M to the platen 10 in the state in which the platen 10 is disposed on the elevator mechanism 74. When the medium M is the T-shirt, for example, the medium M is attached to the platen 10 such that the neckline of the T-shirt is oriented in the rearward direction of the platen 10. The elevator mechanism 74 conveys the platen 10 to the rear, and transfers the platen 10 to the outward path 72.

The outward path 72 conveys the platen 10 in the rearward direction to the transfer mechanism 81. The transfer mechanism 81 moves up to a position higher than the outward path 72. In this way, the platen 10 is transferred from the outward path 72 to the transfer mechanism 81. The transfer mechanism 81 rotates the platen 10 in the clockwise direction by 90° in a plan view, and conveys the platen 10 in the rightward direction. In this way, the platen 10 is transferred from the transfer mechanism 81 to the conveyance path 32. The application device 3A performs the application processing.

When the application processing by the application device 3A is complete, the conveyance path 32 conveys the platen 10 in the leftward direction, and transfers the platen 10 to the transfer mechanism 81. The transfer mechanism 81 rotates the platen 10 in the counterclockwise direction by 90° in a plan view, and moves down to a position lower than the outward path 72. In this way, the platen 10 is transferred from the transfer mechanism 81 to the outward path 72.

A transfer mode of the platens 10 by each of the transfer mechanisms 82 to 89 is the same as the transfer mode of the platen 10 by the transfer mechanism 81. Thus, hereinafter, a description of the transfer of the platens 10 by each of the transfer mechanisms 82 to 89 will be omitted or simplified.

The outward path 72 conveys the platen 10 in the rearward direction to the transfer mechanism 82 or to the transfer mechanism 83. Which of the transfer mechanisms 82 and 83 the platen 10 is conveyed to is determined based on which of the first drying devices 4A, 4B, 4C, and 4D is to perform the first drying processing. For example, a case will be described in which the first drying processing is to be performed by the first drying device 4A. In this case, the platen 10 is conveyed to the transfer mechanism 82, and is transferred to the transfer mechanism 82 from the outward path 72. The transfer mechanism 82 conveys the platen 10 in the rightward direction, and transfers the platen 10 to the conveyance path 49. The first drying device 4A executes the first drying processing. When the first drying processing by the first drying device 4A is complete, the conveyance path 49 conveys the platen 10 in the leftward direction, and transfers the platen 10 to the transfer mechanism 82. The transfer mechanism 82 transfers the platen 10 to the outward path 72.

The outward path 72 conveys the platen 10 in the rearward direction, and transfers the platen 10 to the transfer mechanism 84. For example, a case will be described in which the heat press processing is to be performed by the heat press device 5A. In this case, the transfer mechanism 84 conveys the platen 10 in the rightward direction and transfers the platen 10 to the conveyance path 53. The heat press device 5A performs the heat press processing. When the heat press processing by the heat press device 5A is complete, the conveyance path 53 conveys the platen 10 in the leftward direction, and transfers the platen 10 to the transfer mechanism 84. The transfer mechanism 84 transfers the platen 10 to the outward path 72.

The outward path 72 conveys the platen 10 in the rearward direction to the transfer mechanism 85 or the transfer mechanism 86. Which of the transfer mechanisms 85 and 86 the platen 10 is conveyed to is determined based on which of the printers 2A, 2B, 2C, and 2D is to perform the print processing. For example, a case will be described in which the print processing is performed by the printer 2A. In this case, the platen 10 is conveyed to the transfer mechanism 85, and is transferred to the transfer mechanism 85 from the outward path 72. The transfer mechanism 85 conveys the platen 10 in the rightward direction, and transfers the platen 10 to the sub-scanning conveyance mechanism 23 via the connecting conveyance path 85A. The printer 2A performs the print processing. When the print processing by the printer 2A is complete, the sub-scanning conveyance mechanism 23 conveys the platen 10 in the leftward direction, and transfers the platen 10 to the transfer mechanism 85 via the connecting conveyance path 85A. The transfer mechanism 85 transfers the platen 10 to the outward path 72.

The outward path 72 conveys the platen 10 in the rearward direction and transfers the platen 10 to the transfer mechanism 87, the transfer mechanism 88, or the transfer mechanism 89. Which of the transfer mechanisms 87, 88, and 89 the platen 10 is conveyed to is determined based on which of the second drying devices 6A, 6B, 6C, 6D, 6E, and 6F performs the second drying processing. For example, a case will be described in which the second drying processing is to be performed by the second drying device 6A. In this case, the platen 10 is conveyed to the transfer mechanism 87, and is transferred to the transfer mechanism 87 from the outward path 72. The transfer mechanism 87 conveys the platen 10 in the rightward direction, and transfers the platen 10 to a conveyance path (not shown in the drawings) of the second drying device 6A. The second drying device 6A performs the second drying processing. When the second drying processing by the second drying device 6A is complete, the conveyance path (not shown in the drawings) of the second drying device 6A conveys the platen 10 in the leftward direction, and transfers the platen 10 to the transfer mechanism 87. The transfer mechanism 87 transfers the platen 10 to the outward path 72.

The outward path 72 conveys the platen 10 in the rearward direction, and transfers the platen 10 to the elevator mechanism 75. The elevator mechanism 75 moves down to the same height as the return path (not shown in the drawings). The elevator mechanism 75 conveys the platen 10 in the forward direction, and transfers the platen 10 to the return path. In a state in which the elevator mechanism 74 is disposed at the same height as the return path, the return path conveys the platen 10 in the forward direction, and transfers the platen 10 to the elevator mechanism 74. The user removes the medium M, on which the image has been printed, from the platen 10, during a period in which the platen 10 is conveyed from the elevator mechanism 75 to the elevator mechanism 74 via the return path. For example, the user removes the medium M, on which the image has been printed, from the platen 10 in a state in which the platen 10 is disposed on the elevator mechanism 75. Subsequently, the user attaches the medium M to the platen 10 in a state in which the platen 10 is disposed on the elevator mechanism 74. Thereafter, the same operations by the print system 1 are repeated.

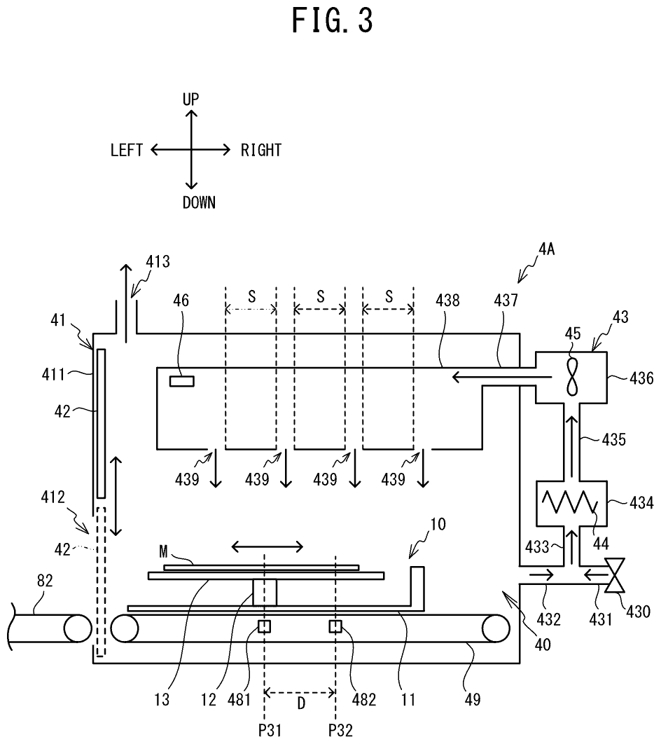

The detailed configuration of the first drying device 4A will be described with reference to FIG. 3. The first drying device 4A is provided with a housing 41, a shutter 42, the conveyance path 49, an air supply path 43, a heater 44, a fan 45, a temperature sensor 46, a first position sensor 481, and a second position sensor 482. The housing 41 is a rectangular parallelopiped shape, and has a box shape. A space 40 is provided in the interior of the housing 41. The space 40 is a region surrounded by the inner walls of the housing 41. Hereinafter, the space 40 will also be referred to as “inside the housing 41”. An exhaust outlet 413 is provided in an upper left portion of the housing 41. The exhaust outlet 413 is an opening, and is connected to the space 40. The exhaust outlet 413 discharges the air inside the housing 41 to the outside of the housing 41.

A passage opening 412 is provided in a left surface 411 of the housing 41. The passage opening 412 is an opening, and penetrates the left surface 411 in the left-right direction. The passage opening 412 is a region defined by edges of the opening provided in the left surface 411. The passage opening 412 is connected to the space 40. The passage opening 412 has a rectangular shape in a left side view, and has a size through which the platen 10 passes. In other words, the length of the passage opening 412 in the left-right direction is larger than the length of the whole of the platen 10 in the left-right direction. The length of the passage opening 412 in the up-down direction is larger than the length of the whole of the platen 10 in the up-down direction. The size of the passage opening 412 is not limited to a particular size, and the length thereof in the front-rear direction is approximately 50 cm and the length thereof in the up-down direction is approximately 40 cm, for example. Thus, the platen 10 can pass through the passage opening 412 and can move in and out of the housing 41.

The shutter 42 is supported by the left surface 411 of the housing 41 so as to be able to move in the up-down direction. The shutter 42 is a plate, and has a rectangular shape in a left side view. The shutter 42 opens the passage opening 412 by moving upward, and covers the passage opening 412 by moving downward. As a result of the shutter 42 covering the passage opening 412, air is suppressed from moving in and out of the housing 41 via the passage opening 412.

The conveyance path 49 is disposed at a lower portion of the space 40, and extends in the left-right direction. The left end of the conveyance path 49 is disposed in the vicinity of the left surface 411 of the housing 41. In the up-down direction, the conveyance path 49 is disposed at a height that is the same as that of the transfer mechanism 82 when the transfer mechanism 82 moves up to the position higher than the outward path 72.

The air supply path 43 is a pipe, and constitutes a flow path of the air. In the present embodiment, the air supply path 43 is provided with an outside air introduction path 431, connecting paths 432 and 433, a heating chamber 434, a connecting path 435, an air supply chamber 436, a connecting path 437, and an air blowing chamber 438. The right end of the outside air introduction path 431 is open to the outside air. The left end of the outside air introduction path 431 is connected to each of the right end of the connecting path 432 and the lower end of the connecting path 433. A valve 430 is provided in the outside air introduction path 431. The valve 430 is normally open. The valve 430 is closed when the first drying device 4A is not used for a long period and the like. In this way, the valve 430 suppresses foreign matter, such as dust and the like, from entering into the housing 41 via the outside air introduction path 431.

The left end of the connecting path 432 is connected to the inside of the housing 41. The heating chamber 434 is connected to the upper end of the connecting path 433. The lower end of the connecting path 435 is connected to the heating chamber 434. The air supply chamber 436 is connected to the upper end of the connecting path 435. The right end of the connecting path 437 is connected to the air supply chamber 436. The air blowing chamber 438 is connected to the left end of the connecting path 437. The air blowing chamber 438 is disposed at the upper portion of the space 40. The lower surface of the air blowing chamber 438 is disposed to be higher than the conveyance path 49, and faces the conveyance path 49 in the up-down direction.

A plurality of air blowing outlets 439 are provided in the lower surface of the air blowing chamber 438. The plurality of air blowing outlets 439 are aligned in the left-right direction, and are open downward toward the space 40. An interval S between pairs of the air blowing outlets 439 adjacent to each other in the left-right direction, of the plurality of air blowing outlets 439, is constant.

The heater 44 is housed inside the heating chamber 434. The heater 44 is a heat source, and heats the air inside the heating chamber 434. Hereinafter, the air heated by the heater 44 will be referred to as “heated air”. The fan 45 is housed in the air supply chamber 436. The fan 45 is an air blower, and blows air toward the heating chamber 434.

The temperature sensor 46 is disposed in the air blowing chamber 438, and detects the temperature of the air of the air blowing chamber 438. The temperature sensor 46 is a thermistor in the present embodiment, but may be a thermocouple, an infrared sensor, and the like. The first position sensor 481 is provided at a first housed position P31 to be described below, and detects the platen 10 positioned at the first housed position P31. The second position sensor 482 is provided at a second housed position P32 to be described below, and detects the platen 10 positioned at the second housed position P32. In the present embodiment, each of the first position sensor 481 and the second position sensor 482 is a proximity switch, but may be a limit switch, an infrared sensor, or the like.

For example, a detection plate is provided at the center of the attachment plate 13, in the front-rear direction of the platen 10 (the left-right direction in FIG. 3). The first position sensor 481 detects the platen 10 positioned at the first housed position P31, by detecting the detection plate when the detection plate passes the first housed position P31. The second position sensor 482 detects the platen 10 positioned at the second housed position P32, by detecting the detection plate when the detection plate passes the second housed position P32.

A drying operation of the first drying device 4A will be described. The platen 10, on which is placed the medium M to which the treatment liquid has been applied, is housed in the space 40, that is, the platen 10 on which the medium M is placed that has been subject to the application processing. The state in which the platen 10 is housed in the space 40 will be referred to as a “housed state”. The drying operation is performed in the housed state. In the drying operation, the heater 44 heats the air inside the heating chamber 434. The fan 45 blows air toward the heating chamber 434. In this way, the heated air flows from the heating chamber 434 in the order of the connecting path 435, the air supply chamber 436, and the connecting path 437. The heated air flowing from the connecting path 437 to the air blowing chamber 438 is blown out in the downward direction from the air blowing chamber 438 via the plurality of air blowing outlets 439, into the space 40. The heated air blown out from the plurality of air blowing outlets 439 is blown against the medium M on the platen 10, in the space 40. In this way, the moisture content in the treatment liquid in the medium M on the platen 10 evaporates.

Furthermore, in the present embodiment, the conveyance path 49 conveys the platen 10 in the left-right direction in a reciprocating manner between the first housed position P31 and the second housed position P32 in the drying operation. The first housed position P31 and the second housed position P32 are positions on the conveyance path 49. The second housed position P32 is positioned further to the right than the first housed position P31. In the left-right direction, a distance D between the first housed position P31 and the second housed position P32 is larger than the interval S. In the present embodiment, the position of the platen 10 is defined, in the front-rear direction of the platen 10 (the left-right direction in FIG. 3) by the center of the attachment plate 13. In the present embodiment, the position of the platen 10 is defined by a position, of the platen 10, at which the detection plate is provided. Both when the platen 10 is positioned at the first housed position P31 and at the second housed position P32, the whole of the platen 10 is disposed in the space 40.

An air supply state in the first drying device 4A will be described. The air supply state is a state of the heated air supplied to the space 40 by the fan 45. For example, when at least one of an air flow amount by the fan 45 or a heating temperature by the heater 44 varies, the air supply state varies.

For example, in the first drying processing, when the air supply state varies, the heated state of the medium M on the platen 10 changes. Specifically, when the heating temperature is too high, there is a possibility that the medium M may be scorched, or may be discolored. When the air flow amount is too great, there is a possibility that the treatment liquid on the medium M may flow outside a target region of application.

When the heating temperature is too low, or when the air flow amount is too small, there is a possibility that progress in the drying of the medium M may become slow. Thus, there is a possibility that a processing time of the first drying processing may become long, or that insufficient drying of the medium M may occur. For example, when the insufficient drying of the medium M occurs, there is a possibility that insufficient fixing of the treatment liquid to the medium M may occur, and the fixing and color development of the ink to the medium M by the print processing may deteriorate as a result. Furthermore, there is a possibility that bleeding of the treatment liquid applied to the medium M by the application processing and of the ink applied to the medium M by the print processing is more likely to be conspicuous. The first drying device 4A contributes to adjusting the heated state of the medium M by performing first drying control processing to be described below.

Note that, in the present embodiment, the air supply state does not include a state in which the rotation of the fan 45 and the heating of the heater 44 are stopped. Thus, the starting of the rotation of the fan 45 and the heating of the heater 44, from a state in which the rotation of the fan 45 and the heating of the heater 44 are stopped, does not mean a switching of the air supply state. Similarly, the stopping of the rotation of the fan 45 and the heating of the heater 44, from a state in which the rotation of the fan 45 and the heating of the heater 44 are being performed, does not mean a switching of the air supply state.

The electrical configuration of the first drying device 4A will be described with reference to FIG. 4. The first drying device 4A is provided with a CPU 141, a ROM 142, a RAM 143, and a flash memory 144. The CPU 141 controls the first drying device 4A, and functions as a processor. The CPU 141 controls the first drying processing, for example. The CPU 141 is electrically connected to the ROM 142, the RAM 143, and the flash memory 144.

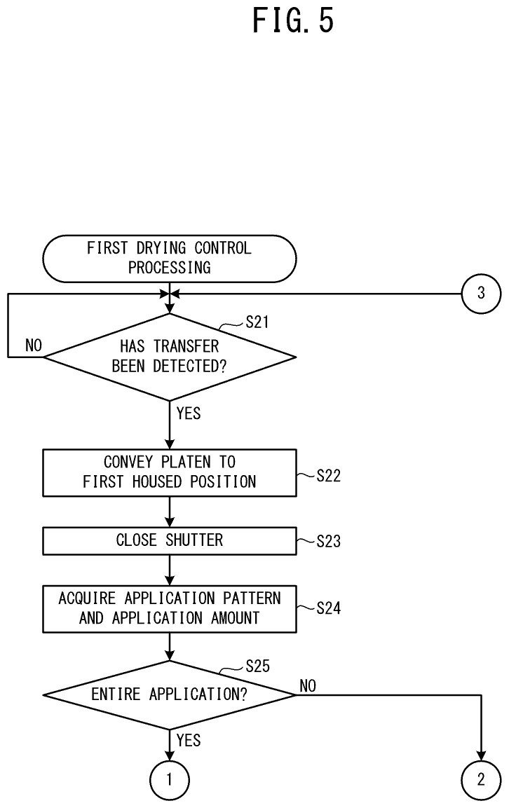

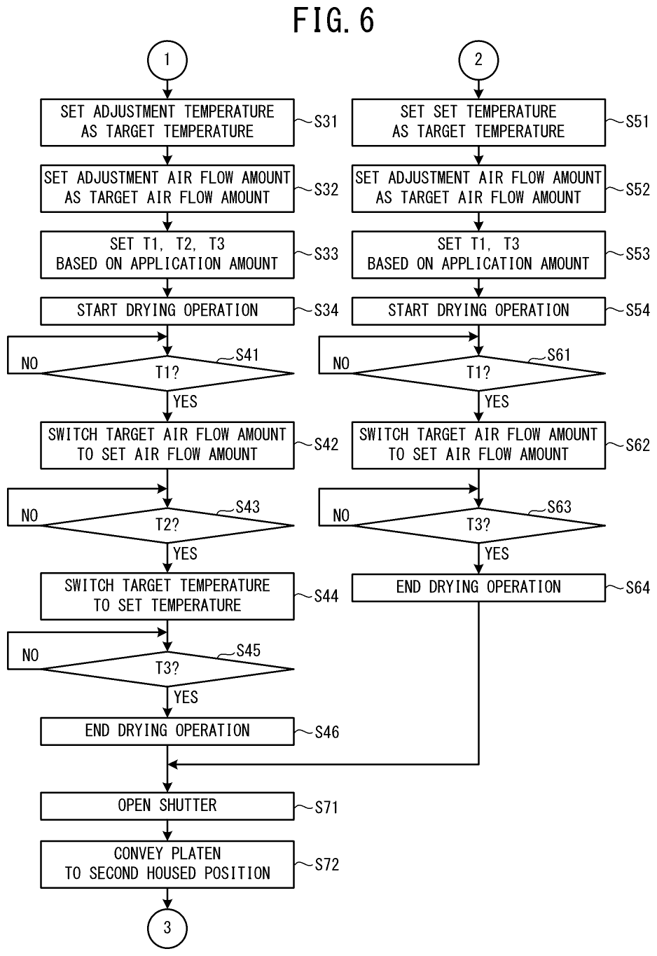

The ROM 142 stores control programs used for the CPU 141 to control the operations of the first drying device 4A, and information and the like necessary for the CPU 141 when executing various programs. The control program includes a first drying control program for executing the first drying control processing (refer to FIG. 5 and FIG. 6) to be described below. The RAM 143 temporarily stores various data and the like used by the control programs. The flash memory 144 is non-volatile, and stores a set temperature, a set air flow amount, and the like. The set temperature is a heating temperature of the heater 44 set by the user via an operation portion 483. The set air flow amount is an air flow amount by the fan 45 set by the user via the operation portion 483.

The conveyance motor 494 is electrically connected to the CPU 141 via a drive circuit 493. The conveyance motor 494 drives the conveyance path 49. The drive circuit 493 controls the conveyance motor 494 based on a control signal from the CPU 141. An opening/closing motor 422 is electrically connected to the CPU 141 via a drive circuit 421. The opening/closing motor 422 opens and closes the shutter 42. The drive circuit 421 controls the opening/closing motor 422 based on a control signal from the CPU 141.

A fan motor 452 is electrically connected to the CPU 141 via a drive circuit 451. The fan motor 452 rotates when energized, and performs the air supply by the fan 45. The drive circuit 451 controls a rotation speed of the fan motor 452 based on a control signal from the CPU 141. For example, the greater the rotation speed of the fan motor 452, the greater the air flow amount by the fan 45.

A heating resistor 442 is electrically connected to the CPU 141 via a drive circuit 441. The heating resistor 442 generates heat when energized, and performs the heating of the air by the heater 44. The drive circuit 441 controls a heating temperature of the heating resistor 442 based on a control signal from the CPU 141. For example, the greater an applied voltage to the heating resistor 442, the higher the heating temperature of the heating resistor 442.

The temperature sensor 46, the first position sensor 481, the second position sensor 482, the operation portion 483, and a communication portion 484 are electrically connected to the CPU 141. The temperature sensor 46 outputs, to the CPU 141, a signal indicating a detected temperature. Based on the signal from the temperature sensor 46, the CPU 141 controls the heater 44 such that the temperature of the heated air is a target temperature to be described below. The first position sensor 481 outputs, to the CPU 141, a signal indicating whether or not the platen 10 is positioned at the first housed position P31. The second position sensor 482 outputs, to the CPU 141, a signal indicating whether or not the platen 10 is positioned at the second housed position P32.

The operation portion 483 is a touch panel display or the like, displays various information, and outputs information to the CPU 141 in accordance with an operation by the user. The set temperature and the set air flow amount are set in advance by the user operating the operation portion 483.

The communication portion 484 is a controller for communicating in a wired or wireless manner with another device. The CPU 141 communicates with each of the other devices of the print system 1, for example, using the communication portion 484. The other devices of the print system 1 are, for example, the printers 2A, 2B, 2C, and 2D, the application device 3A, the first drying devices 4B, 4C, and 4D, the heat press devices 5A and 5B, the second drying devices 6A, 6B, 6C, 6D, 6E, and 6F, and the conveyance device 7. Each of the other devices of the print system 1 is provided with a CPU, a ROM, a RAM, a flash memory, a communication portion, and the like.

In particular, the first drying devices 4B, 4C, and 4D have the same electrical configuration as the first drying device 4A. Furthermore, each of the second drying devices 6A, 6B, 6C, 6D, 6E, and 6F also have the same electrical configuration as the first drying device 4A. The ROM of each of the second drying devices 6A, 6B, 6C, 6D, 6E, and 6F stores a second drying control program for performing second drying control processing (not shown in the drawings) to be described later, instead of the first drying control processing.

The first drying control processing will be described with reference to FIG. 5 to FIG. 10. Hereinafter, a case will be described in which the CPU 141 executes the first drying control processing in the first drying device 4A. In a similar manner to the first drying device 4A, the CPU of each of the first drying devices 4B, 4C, and 4D also executes the first drying control processing. When the power source of the first drying device 4A is turned on, the CPU 141 executes the first drying control processing, by reading out and operating the first drying control program from the ROM 142. In the first drying control processing, the CPU 141 executes the first drying processing, that is, performs control of drying operations by the first drying device 4A.

As shown in FIG. 5, when the first drying control processing is started, the CPU 141 determines whether the platen 10 has been transferred from the transfer mechanism 82 to the conveyance path 49 (refer to FIG. 3) (S21). For example, when the platen 10 has been transferred from the transfer mechanism 82 to the conveyance path 49, a control portion (not shown in the drawings) of the conveyance device 7 transmits a transfer notification to the first drying device 4A. When the CPU 141 has not received the transfer notification from the conveyance device 7, the CPU 141 determines that the platen 10 has not been transferred from the transfer mechanism 82 to the conveyance path 49 (no at S21). In this case, the CPU 141 repeats the determination at S21 until the CPU 141 receives the transfer notification.

When the CPU 141 has received the transfer notification from the conveyance device 7 via the communication portion 484, the CPU 141 determines that the platen 10 has been transferred to the conveyance path 49 from the transfer mechanism 82 (yes at S21). In this case, the CPU 141 controls the conveyance motor 494 based on the detection signal from the first position sensor 481, and conveys the platen 10 to the first housed position P31 (refer to FIG. 3) (S22). In this way, the platen 10 is in a housed state. The CPU 141 controls the opening/closing motor 422 and closes the shutter 42 (refer to FIG. 3) (S23).

As will be described below, the CPU 141 sets a first switching timing T1, a second switching timing T2, and an end timing T3 to be described below, based on at least one of an application pattern by the application processing or an application amount of the treatment liquid onto the medium M by application processing (in the present embodiment, based on both). The application pattern includes two types of an application range, namely, a partial application and an entire application. The partial application is the application pattern in which, in a plan view, a region is present in which the treatment liquid is not applied to the medium M. In other words, the partial application is the application pattern in which, in a plan view, the treatment liquid is applied to only a part of the medium M. In the present embodiment, the partial application is the application pattern in which, of the medium M, the treatment liquid is applied to the print region R1 (refer to FIG. 2), and, of the medium M, the treatment liquid is not applied to the non-print region R2 (refer to FIG. 2). The entire application is the application pattern in which, in a plan view, the region to which the treatment liquid is not applied to the medium M is not present. In other words, the entire application is the application pattern in which, of the medium M, the treatment liquid is applied to both the print region R1 and the non-print region R2, namely, is applied to the entire region of the medium M in a plan view. In the present embodiment, the user can operate an operation portion (not shown in the drawings) of the print system 1, and set the application pattern by the application processing.

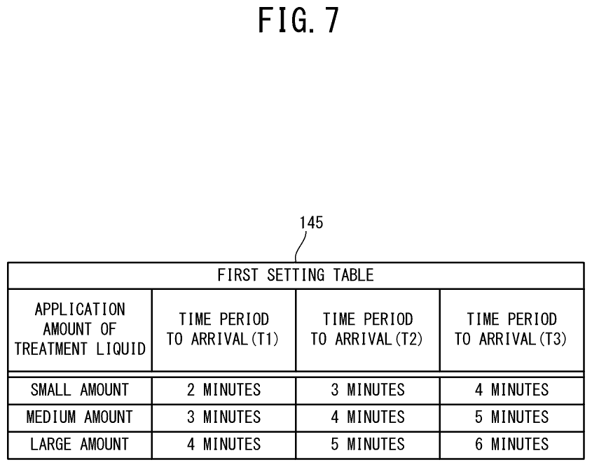

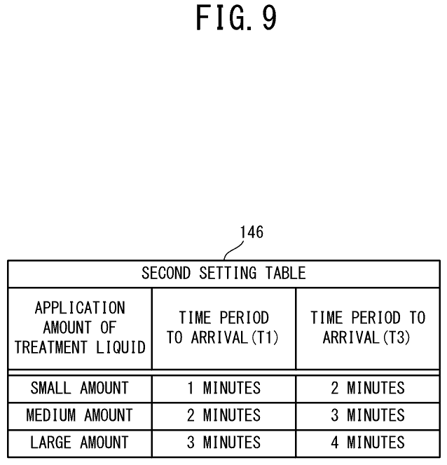

The application amount of the treatment liquid includes “small amount”, “medium amount”, and “large amount” (refer to FIG. 7 and FIG. 9). “Small amount”, “medium amount”, and “large amount” indicate the relative application amount of the treatment liquid in each of the application patterns. For example, the “small amount” of the partial application indicates the smallest amount of the application amount of the treatment liquid, of the “small amount”, “medium amount”, and “large amount” of the partial application. The “large amount” of the partial application indicates the largest amount of the application amount of the treatment liquid, of the “small amount”, “medium amount”, and “large amount” of the partial application. The “medium amount” of the partial application indicates the application amount of the treatment liquid between the “small amount” and “large amount” of the partial application. For example, the “small amount” of the entire application is not limited to being the same amount as the “small amount” of the partial application, and may be a larger amount than the “medium amount” of the partial application. In the present embodiment, the user can operate the operation portion (not shown in the drawings) of the print system 1, and can set the application amount of the treatment liquid onto the medium M, namely, can set a misting amount of the treatment liquid from the application portion 31.

The CPU 141 acquires each of the application pattern by the application processing and the application amount of the treatment liquid onto the medium M by the application processing (S24). In the processing at S24, for example, the CPU 141 transmits, to the application device 3A via the communication portion 484, a request command requesting information indicating each of the application pattern and the application amount of the treatment liquid (hereinafter referred to as “application processing information”). When the control portion of the application device 3A has received the request command for the application processing information, the control portion transmits the application processing information to the first drying device 4A. The CPU 141 receives the application processing information from the application device 3A via the communication portion 484, and stores the received application processing information in the RAM 143.

The CPU 141 determines whether the acquired application pattern is the entire application (S25). When the application pattern is the entire application (yes at S25), the CPU 141 shifts the processing to S31 shown in FIG. 6. When the application pattern is the partial application (no at S25), the CPU 141 shifts the processing to S51 shown in FIG. 6.

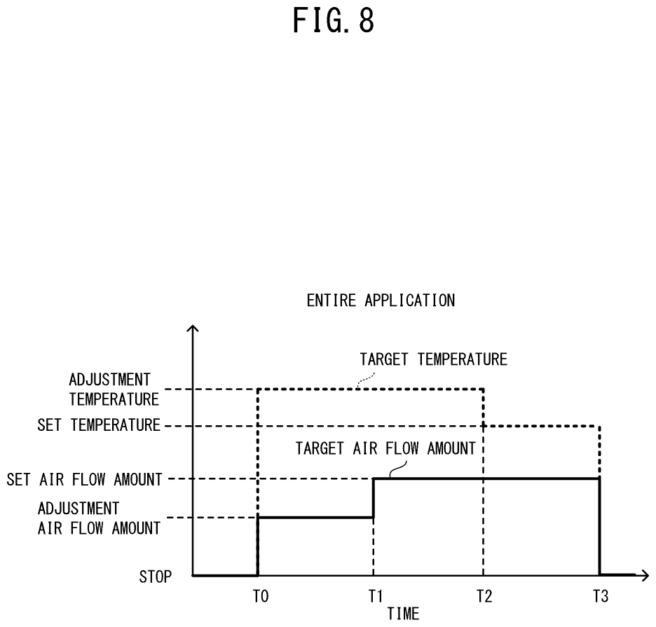

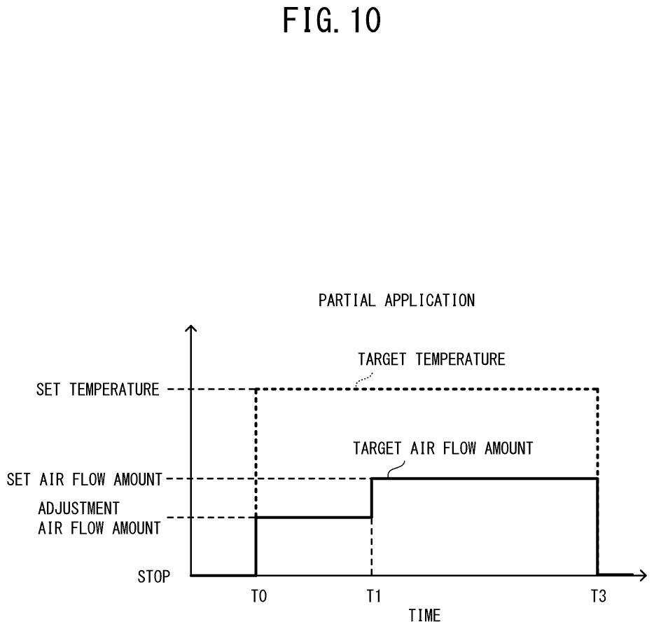

Processing when the entire application is performed will be described. As shown in FIG. 6, the CPU 141 sets an adjustment temperature as the target temperature (refer to FIG. 8) (S31). In FIG. 8, the target temperature is indicated by a dashed line (this also applies to FIG. 10). The target temperature is the heating temperature targeted by the heater 44 (refer to FIG. 3), and is stored in the RAM 143. The adjustment temperature is the heating temperature of the heater 44 that is higher than the set temperature. The adjustment temperature may be higher than an upper limit of the set temperature that can be set, may be a temperature higher than the set temperature by a predetermined ratio, may be a temperature higher than the set temperature by a predetermined temperature, or may be calculated based on the set temperature.

The CPU 141 sets an adjustment air flow amount as a target air flow amount (refer to FIG. 8) (S32). In FIG. 8, the target air flow amount is indicated by a solid line (this also applies to FIG. 10). The target air flow amount is the air flow amount targeted by the fan (refer to FIG. 3), and is stored in the RAM 143. The adjustment air flow amount is the air flow amount by the fan 45 that is smaller than the set air flow amount. The adjustment air flow amount may be smaller than lower limit of the set air flow amount that can be set, may be an air flow amount smaller than the set air flow amount by a predetermined ratio, may be an air flow amount smaller than the set air flow amount by a predetermined air flow amount, or may be calculated based on the set air flow amount.

The CPU 141 refers to a first setting table 145 (refer to FIG. 7), and, based on the application amount of the treatment liquid acquired by the processing at S24, sets the first switching timing T1, the second switching timing T2, and the end timing T3 (S33). The first switching timing T1 is a timing at which the target air flow amount is switched. The second switching timing T2 is a timing at which the target temperature is switched. The end timing T3 is a timing at which the drying operation by the first drying device 4A is stopped.

The first setting table 145 will be described with reference to FIG. 7. The first setting table 145 is stored in the flash memory 144. Hereinafter, a timing at which the drying operation is started will be referred to as a “start timing TO” (refer to FIG. 8), and a time period from the start timing T0 to until arriving at a chosen timing will be referred to as a “time period to arrival”.

The first setting table 145 establishes the time periods to arrival of each of the first switching timing T1, the second switching timing T2, and the end timing T3 in accordance with the application amount of the treatment liquid. In the present embodiment, the time periods to arrival of the first switching timing T1 are established as “2 minutes”, “3 minutes”, and “4 minutes”, respectively, corresponding to the “small amount”, “medium amount”, and “large amount” of the application amount of the treatment liquid. For example, when the air of the set air flow amount is blown against the medium M, the treatment liquid on the medium M may flow. In the first setting table 145, for example, the first switching timing T1 is established based on a time period until the treatment liquid on the medium M evaporates, to a degree that the treatment liquid on the medium M does not flow even when the air of the set air flow amount is blown against the medium M. Note that the first switching timing T1 is established based on the same time periods in a second setting table 146 (refer to FIG. 9) to be described below.

The time periods to arrival of the second switching timing T2 are established as “3 minutes”, “4 minutes”, and “5 minutes”. For example, when sufficient treatment liquid is contained in the medium M, even when the air of the adjustment temperature is blown against the medium M, the temperature of the medium M does not exceed a predetermined temperature. The predetermined temperature is 100° C., for example. In the first setting table 145, for example, the second switching timing T2 is established based on a time period until the treatment liquid on the medium M evaporates, to a degree that the temperature of the medium M exceeds the predetermined temperature when the air of the adjustment temperature is blown against the medium M. For example, the second switching timing T2 is a timing at which an evaporation amount of the moisture content in the treatment liquid applied to the medium M is an amount that is 80% to 90% of the moisture content of the treatment liquid applied to the medium M. The time periods to arrival of the end timing T3 are established as “4 minutes”, “5 minutes”, and “6 minutes”.

According to the configuration of the above-described first setting table 145, for example, the greater the application amount of the treatment liquid, the longer the time period to arrival of the first switching timing T1. The greater the application amount of the treatment liquid, the longer the time period to arrival of the second switching timing T2. The greater the application amount of the treatment liquid, the longer the time period to arrival of the end timing T3.

When the application amount of the treatment liquid is the “small amount”, the time period to arrival of the second switching timing T2 of “3 minutes” is longer than the time period to arrival of the first switching timing T1 of “2 minutes”, and the time period to arrival of the end timing T3 of “4 minutes” is longer than the time period to arrival of the second switching timing T2 of “3 minutes”. Also, when the application amount of the treatment liquid is the “medium amount” and the “large amount”, in a similar manner, the time period to arrival of the second switching timing T2 is longer than the time period to arrival of the first switching timing T1, and the time period to arrival of the end timing T3 is longer than the time period to arrival of the second switching timing T2. Thus, of the first switching timing T1, the second switching timing T2, and the end timing T3, the first switching timing T1 is reached first. The second switching timing T2 is reached after reaching the first switching timing T1. The end timing T3 is reached after reaching the second switching timing T2.

For example, a case will be described in which the application amount of the treatment liquid is the “medium amount”. In this case, in the processing at S33 shown in FIG. 6, the CPU 141 refers to the first setting table 145 and identifies “3 minutes”, “4 minutes”, and “5 minutes” corresponding to the “medium amount” application amount of the treatment liquid, as the respective time periods to arrival of the first switching timing T1, the second switching timing T2, and the end timing T3. The CPU 141 sets the first switching timing T1 based on the identified “3 minutes”, sets the second switching timing T2 based on the identified “4 minutes”, and sets the end timing T3 based on the identified “5 minutes”.

As shown in FIG. 6, in the housed state, the CPU 141 starts the drying operation (S34). An execution timing of the processing at S34 is the start timing TO shown in FIG. 8. In the processing at S34, the CPU 141 controls the heating resistor 442, and drives the heater 44 (refer to FIG. 3) using the target temperature set as the adjustment temperature by the processing at S31. In this way, the air inside the heating chamber 434 (refer to FIG. 3) is heated using the adjustment temperature. The CPU 141 controls the fan motor 452, and drives the fan 45 (refer to FIG. 3) at the target air flow amount set as the adjustment air flow amount by the processing at S32. In this way, the heated air is supplied to the space 40 (refer to FIG. 3) using the adjustment air flow amount.

Furthermore, the CPU 141 controls the conveyance motor 494 based on the detection signals from the first position sensor 481 and the second position sensor 482, and conveys the platen 10 in the reciprocating manner in the left-right direction between the first housed position P31 and the second housed position P32, in the conveyance path 49 (refer to FIG. 3). As a result of the drying operation, in the medium M on the platen 10, the moisture content of the treatment liquid evaporates.

The CPU 141 determines whether the first switching timing T1 (refer to FIG. 8) set by the processing at S33 has been reached (S41). When the first switching timing T1 has not been reached (no at S41), the CPU 141 repeats the determination at S41 until the first switching timing T1 is reached. When the first switching timing T1 has been reached (yes at S41), the CPU 141 switches the target air flow amount from the adjustment air flow amount to the set air flow amount (S42). In this way, the CPU 141 controls the fan motor 452, and drives the fan 45 (refer to FIG. 3) using the target air flow amount set as the set air flow amount by the processing at S42. Thus, the heated air is supplied to the space 40 (refer to FIG. 3) using the set air flow amount that is greater than the adjustment air flow amount. In the housed state, by switching the target air flow amount from the adjustment air flow amount to the set air flow amount, the air supply state is switched.

The CPU 141 determines whether the second switching timing T2 (refer to FIG. 8) set by the processing at S33 has been reached (S43). When the second switching timing T2 has not been reached (no at S43), the CPU 141 repeats the determination at S43 until the second switching timing T2 has been reached. When the second switching timing T2 has been reached (yes at S43), the CPU 141 switches the target temperature from the adjustment temperature to the set temperature (S44). In this way, the CPU 141 controls the heating resistor 442, and drives the heater 44 (refer to FIG. 3) using the target temperature set as the set temperature by the processing at S44. Thus, the air inside the heating chamber 434 (refer to FIG. 3) is heated using the set temperature that is lower than the adjustment temperature. In the housed state, by switching the target temperature from the adjustment temperature to the set temperature, the air supply state is switched.

The CPU 141 determines whether the end timing T3 (refer to FIG. 8) set by the processing at S33 has been reached (S45). When the end timing T3 has not been reached (no at S45), the CPU 141 repeats the determination at S45 until the end timing T3 has been reached.

When the end timing T3 has been reached (yes at S45), the CPU 141 stops the drying operation (S46). Specifically, the CPU 141 stops the energization of the heating resistor 442 and stops the heating by the heater 44 (refer to FIG. 3). The CPU 141 stops the driving of the fan motor 452, and stops the rotation of the fan 45 (refer to FIG. 3). The CPU 141 stops the driving of the conveyance motor 494, and stops the conveyance of the platen 10 by the conveyance path 49. The CPU 141 shifts the processing to processing at S71.

Processing when the partial application is performed will be described. The CPU 141 sets the set temperature as the target temperature (refer to FIG. 10) (S51). The CPU 141 sets the adjustment air flow amount as the target air flow amount (refer to FIG. 10) (S52). The CPU 141 refers to the second setting table 146 (refer to FIG. 9) shown in FIG. 9, and sets the first switching timing T1 and the end timing T3, based on the application amount of the treatment liquid acquired by the processing at S24 (S53).

The second setting table 146 will be described with reference to FIG. 9. The second setting table 146 is stored in the flash memory 144. The second setting table 146 establishes the time periods to arrival of each of the first switching timing T1 and the end timing T3 in accordance with the application amount of the treatment liquid.

In the present embodiment, the time periods to arrival of the first switching timing T1 are established as “1 minute”, “2 minutes”, and “3 minutes”, respectively, corresponding to the “small amount”, “medium amount”, and “large amount” of the application amount of the treatment liquid. The time periods to arrival of the end timing T3 are established as “2 minutes”, “3 minutes”, and “4 minutes”.

According to the configuration of the above-described second setting table 146, for example, the greater the application amount of the treatment liquid, the longer the time period to arrival of the first switching timing T1. The greater the application amount of the treatment liquid, the longer the time period to arrival of the end timing T3.

When the application amount of the treatment liquid is “small amount”, the time period to arrival of the end timing T3 of “2 minutes” is longer than the time period to arrival of the first switching timing T1 of “1 minute”. Also, when the application amount of the treatment liquid is the “medium amount” and the “large amount”, in a similar manner, the time period to arrival of the end timing T3 is longer than the time period to arrival of the first switching timing T1. Thus, the end timing T3 is reached after reaching the first switching timing T1.

For example, a case will be described in which the application amount of the treatment liquid is “medium amount”. In this case, in the processing at S53 shown in FIG. 6, the CPU 141 refers to the second setting table 146, and identifies “2 minutes” and “3 minutes” corresponding to the “medium amount” application amount of the treatment liquid, as the respective time periods to arrival of the first switching timing T1 and the end timing T3. The CPU 141 sets the first switching timing T1 based on the identified “2 minutes” and sets the end timing T3 based on the identified “3 minutes”.

As shown in FIG. 6, in the housed state, the CPU 141 starts the drying operation (S54). An execution timing of the processing at S54 is the start timing TO shown in FIG. 10. In the processing at S54, the CPU 141 controls the heating resistor 442, and drives the heater 44 (refer to FIG. 3) using the target temperature set as the set temperature by the processing at S51. In this way, the air inside the heating chamber 434 (refer to FIG. 3) is heated using the set temperature. The CPU 141 controls the fan motor 452, and drives the fan 45 (refer to FIG. 3) using the target air flow amount set as the adjustment air flow amount by the processing at S52. In this way, the heated air is supplied to the space 40 (refer to FIG. 3) using the adjustment air flow amount. The CPU 141 controls the conveyance motor 494 based on the detection signals from the first position sensor 481 and the second position sensor 482, and conveys the platen 10 in the reciprocating manner in the left-right direction between the first housed position P31 and the second housed position P32 (refer to FIG. 3). As a result of the drying operation, in the medium M on the platen 10, the moisture content of the treatment liquid evaporates.

The CPU 141 determines whether the first switching timing T1 (refer to FIG. 10) set by the processing at S53 has been reached (S61). When the first switching timing T1 has not been reached (no at S61), the CPU 141 repeats the determination at S61 until the first switching timing T1 has been reached. When the first switching timing T1 has been reached (yes at S61), the CPU 141 switches the target air flow amount from the adjustment air flow amount to the set air flow amount (S62). In this way, the CPU 141 controls the fan motor 452, and drives the fan 45 (refer to FIG. 3) using the target air flow amount set as the set air flow amount by the processing at S62. Thus, the heated air is supplied to the space 40 (refer to FIG. 3) using the set air flow amount that is greater than the adjustment air flow amount. In the housed state, by switching the target air flow amount from the adjustment air flow amount to the set air flow amount, the air supply state is switched.

The CPU 141 determines whether the end timing T3 (refer to FIG. 10) set by the processing at S53 has been reached (S63). When the end timing T3 has not been reached (no at S63), the CPU 141 repeats the determination at S63 until the end timing T3 has been reached.

When the end timing T3 has been reached (yes at S63), the CPU 141 stops the drying operation (S64). Specifically, the CPU 141 stops the energization of the heating resistor 442 and stops the heating by the heater 44 (refer to FIG. 3). The CPU 141 stops the driving of the fan motor 452, and stops the rotation of the fan 45 (refer to FIG. 3). The CPU 141 stops the driving of the conveyance motor 494, and stops the conveyance of the platen 10 by the conveyance path 49 (refer to FIG. 3). The CPU 141 shifts the processing to the processing at S71.

When the drying operation is stopped by the processing at S46 or at S64, the CPU 141 controls the opening/closing motor 422, and opens the shutter 42 (refer to FIG. 3) (S71). The CPU 141 controls the conveyance motor 494, and conveys the platen 10 in the leftward direction in the conveyance path 49 (refer to FIG. 3) (S72). In this way, the platen 10 is transferred to the transfer mechanism 82 (refer to FIG. 1). The CPU 141 returns the processing to the determination at S21 shown in FIG. 5.

The second drying control processing will be described. Hereinafter, a case will be described in which the CPU of the second drying device 6A executes the second drying control processing. In the second drying devices 6B, 6C, 6D, 6E, and 6F also, in a similar manner to the second drying device 6A, the respective CPUs execute the second drying control processing. When the power source of the second drying device 6A is turned on, the CPU of the second drying device 6A executes the second drying control processing, by reading out and operating the second drying control program from the ROM of the second drying device 6A. In the second drying control processing, the CPU of the second drying device 6A, executes the second drying processing, that is, performs control of drying operations by the second drying device 6A.

In the second drying control processing, in a similar manner to the first drying control processing, each of the processing steps from the processing at S21 shown in FIG. 5 to the processing at S72 shown in FIG. 6 is repeated. Hereinafter, of each of the processing steps of the second drying control processing, points that are different from the content of the first drying control processing will be mainly described.

In the processing at S21 shown in FIG. 5, the CPU of the second drying device 6A determines whether the platen 10 has been transferred from the transfer mechanism 87 (refer to FIG. 1) to the conveyance path of the second drying device 6A (S21). When the platen 10 has not been transferred from the transfer mechanism 87 to the conveyance path of the second drying device 6A (no at S21), the CPU of the second drying device 6A repeats the determination at S21.

When the platen 10 has been transferred from the transfer mechanism 87 to the conveyance path of the second drying device 6A (yes at S21), the CPU of the second drying device 6A shifts the processing to S22 shown in FIG. 5. As a result of the processing at S22, the platen 10, on which is placed the medium M to which the ink has been applied, is housed in the space (inside the housing) of the second drying device 6A, that is, the platen 10 on which the medium M is placed that has been subject to the print processing.

In the processing at S24 shown in FIG. 5, the CPU of the second drying device 6A respectively acquires a print pattern by the print processing, and an application amount of the ink onto the medium M by the print processing, namely, a discharge amount of the ink from the inject head 21. In the present embodiment, the user can operate the operation portion (not shown in the drawings) of the print system 1 and can set the print pattern by the print processing. Specifically, the print pattern includes two types, namely, partial printing and entire printing. The partial printing is the print pattern in which, in a plan view, a region is present in which the ink is not applied to the medium M. In other words, the partial printing is the print pattern in which, in a plan view, the ink is applied to only a part of the medium M. The entire printing is the print pattern in which, in a plan view, the region to which the ink is not applied to the medium M is not present. In other words, the entire printing is the print pattern in which the ink is applied to the entire region of the medium M in a plan view.

Furthermore, in the present embodiment, the user can operate the operation portion (not shown in the drawings) of the print system 1, and can set the application amount of the ink onto the medium M, that is, the discharge amount of the ink from the inkjet head 21. For example, the greater the application amount of the ink, the better the image quality.

In the processing at S25 shown in FIG. 5, the CPU of the second drying device 6A determines whether the print patter is the entire printing. When the print pattern is the entire printing (yes at S25), the CPU of the second drying device 6A shifts the processing to S31 shown in FIG. 6. When the print pattern is the partial printing (no at S25), the CPU of the second drying device 6A shifts the processing to S51 shown in FIG. 6.

In the processing at S33 shown in FIG. 6, the CPU of the second drying device 6A refers to a third setting table (not shown in the drawings), and sets the first switching timing T1, the second switching timing T2, and the end timing T3, based on the application amount of the ink.

The third setting table is stored in the flash memory of the second drying device 6A. The basic configuration of the third setting table is the same as that of the first setting table 145 (refer to FIG. 7). The first setting table 145 establishes the time periods to arrival of each of the first switching timing T1, the second switching timing T2, and the end timing T3 in accordance with the application amount of the treatment liquid. In contrast to this, the third setting table establishes the time periods to arrival of each of the first switching timing T1, the second switching timing T2, and the end timing T3 in accordance with the application amount of the ink. Each of the time periods to arrival established by the third setting table may be the same as each of the time periods to arrival established by the first setting table 145, or may be different. In the present embodiment, each of the time periods to arrival established by the third setting table are longer than each of the time periods to arrival established by the first setting table 145.

In the processing at S53 shown in FIG. 6, the CPU of the second drying device 6A refers to a fourth setting table (not shown in the drawings), and sets the first switching timing T1 and the end timing T3 based on the application amount of the ink.

The fourth setting table is stored in the flash memory of the second drying device 6A. The basic configuration of the fourth setting table is the same as that of the second setting table 146 (refer to FIG. 9). The second setting table 146 establishes the time periods to arrival of each of the first switching timing T1 and the end timing T3 in accordance with the application amount of the treatment liquid. In contrast to this, the fourth setting table establishes the time periods to arrival of each of the first switching timing T1 and the end timing T3 in accordance with the application amount of the ink. Each of the time periods to arrival established by the fourth setting table may be the same as each of the time periods of arrival established by the second setting table 146, or may be different. In the present embodiment, each of the time periods to arrival established by the fourth setting table are longer than each of the time periods to arrival established by the second setting table 146.

As a result of the drying operation by the processing at S34 or at S54 shown in FIG. 6, in the medium M on the platen 10, the moisture content of the ink evaporates. In the processing at S72 shown in FIG. 6, the CPU of the second drying device 6A controls the conveyance motor of the second drying device 6A, and conveys the platen 10 in the leftward direction on the conveyance path of the second drying device 6A. In this way, the platen 10 is transferred to the transfer mechanism 87 (refer to FIG. 1).

The main operational effects according to the above-described embodiment will be described. Hereinafter, a given air supply state will be referred to as a “first air supply state”, and an air supply state different from the first air supply state will be referred to as a “second air supply state”. Furthermore, an air supply state different from the second air supply state will be referred to as a “third air supply state”. The third air supply state may be the same as the first air supply state, or may be different.

In the first drying device 4A, the CPU 141 controls at least one of the heater 44 or the fan 45, in the housed state, and switches the air supply state of the heated air supplied by the fan 45 from the first air supply state to the second air supply state. In this way, in the housed state, the air supply state of the heated air is adjusted. Thus, the first drying device 4A contributes to adjusting the heated state of the medium M.

The CPU 141 switches the air supply state from the first air supply state to the second air supply state by controlling the fan 45 and switching the air flow amount supplied by the fan 45 from the adjustment air flow amount to the set air flow amount. In this way, the first drying device 4A contributes to adjusting the heated state of the medium M in accordance with the progress of the evaporation of the moisture content in the treatment liquid on the medium M, for example.

For example, when a moisture content amount in the treatment liquid on the medium M is large, compared to when the moisture content amount in the treatment liquid on the medium M is small, flowability of the treatment liquid on the medium M is high. The CPU 141 switches the target air flow amount from the adjustment air flow amount to the set air flow amount that is greater than the adjustment air flow amount. In this way, in the first drying device 4A, in a state in which the flowability of the treatment liquid on the medium M is high, the heated air of the set air flow amount, namely, the relatively strong air flow, is suppressed from being blown against the treatment liquid on the medium M. As a result, the first drying device 4A contributes to suppressing the treatment liquid on the medium M from flowing due to the air flow.

The CPU 141 controls the heater 44 and switches the air supply state from the first air supply state to the second air supply state by switching the target temperature by the heater 44 from the adjustment temperature to the set temperature. In this way, the first drying device 4A contributes to adjusting the heated state of the medium M in accordance with the progress of the evaporation of the moisture content in the treatment liquid on the medium M, for example.

For example, there is a possibility that when the air is heated from the start using the set temperature, namely, heating the air using the relatively low temperature, the drying time may become long. The CPU 141 switches the target temperature from the adjustment temperature to the set temperature that is lower than the adjustment temperature. In other words, the CPU 141 heats the air using the adjustment temperature, namely, using the relatively high temperature, before heating the air using the set temperature. Thus, the first drying device 4A contributes to suppressing the drying time from becoming longer.

For example, when the application amount of the treatment liquid onto the medium M is large, the progress of the evaporation of the moisture content in the treatment liquid on the medium M becomes slow. The CPU 141 acquires the application amount of the treatment liquid onto the medium M, and switches the air supply state from the first air supply state to the second air supply state based on the acquired application amount. Thus, the first drying device 4A contributes to adjusting the heated state of the medium M in accordance with the progress of the evaporation of the moisture content in the treatment liquid on the medium M, for example.

When the first switching timing T1 has been reached, the CPU 141 controls the fan 45 and switches the air supply state from the first air supply state to the second air supply state by switching the air flow amount by the fan 45 from the adjustment air flow amount to the set air flow amount that is different from the adjustment air flow amount. When the second switching timing T2 subsequent to the first switching timing T1 has been reached, the CPU 141 controls the heater 44 and switches the air supply state from the second air supply state to the third air supply state that is different from the second air supply state, by switching the target temperature by the heater 44 from the adjustment temperature to the set temperature that is different from the adjustment temperature. According to this configuration, the CPU 141 switches the target air flow amount from the adjustment air flow amount to the set air flow amount earlier, compared to a case in which the second switching timing T2 precedes the first switching timing T1. Thus, the first drying device 4A contributes to adjusting the air flow amount before the evaporation of the moisture content in the treatment liquid on the medium M has relatively progressed. According to the above-described embodiment, the CPU 141 switches the target air flow amount from the adjustment air flow amount to the set air flow amount that is larger than the adjustment air flow amount, before the evaporation of the moisture content in the treatment liquid on the medium M has relatively progressed. In this way, the first drying device 4A contributes to suppressing the drying time from becoming longer.

In the housed state, the CPU 141 controls the conveyance motor 494 and conveys the platen 10 in the reciprocating manner inside the space 40. According to this configuration, even when there is unevenness in the temperature distribution of the air inside the space 40, or even when there is unevenness in the strength of the air flow at each of positions inside the space 40, since the platen 10 is being conveyed in the reciprocating manner, unevenness in the heated state of the medium M is less likely to occur. Thus, the first drying device 4A contributes to suppressing the occurrence of unevenness in the progress of the evaporation of the moisture content in the treatment liquid on the medium M in the conveyance direction.

The plurality of air blowing outlets 439 are aligned in the conveyance direction. Thus, for example, the strength of the blown air differs between a position between a pair of the air blowing outlets 439 adjacent to each other in the conveyance direction, and a position of the air blowing outlet 439. In the housed state, the CPU 141 controls the conveyance motor 494 and conveys the platen 10 in the conveyance direction by the distance D that is larger than the interval S between the pair of air blowing outlets 439 adjacent to each other, of the plurality of air blowing outlets 439. In this way, in the conveyance direction, a predetermined position of the medium M on the platen 10 easily passes both the position between the pair of air blowing outlets 439 and the position of the air blowing outlet 439. Thus, the first drying device 4A contributes to suppressing the occurrence of unevenness in the progress of the evaporation of the moisture content in the treatment liquid on the medium M.

The conveyance path 49 branches from the main path 71, and extends to the space 40. The platen 10, on which the medium M is placed in the state before the ink is discharged by the printers 2A, 2B, 2C and 2D, is conveyed from the main path 71 via the conveyance path 49 in the housing 41. In the housed state, the CPU 141 controls the conveyance motor 494, and conveys the platen 10 on the conveyance path 49 in the reciprocating manner. According to this configuration, since the conveyance path 49 branches from the main path 71, even when the platen 10 is conveyed on the conveyance path 49 in the reciprocating manner in the conveyance direction, the platen 10 on the conveyance path 49 is not likely to obstruct the conveyance of another of the platens 10 on the main path 71. Thus, the first drying device 4A contributes to suppressing the occurrence of unevenness in the progress of the evaporation of the moisture content in the treatment liquid on the medium M in the conveyance direction, while suppressing the obstruction of the conveyance of the other platen 10 on the main path 71.

The main operational effects by the first drying device 4A are described above. The first drying device 4A dries the treatment liquid on the medium M. In contrast to this, the second drying device 6A differs from the first drying device 4A in that the second drying device 6A dries the ink on the medium M. The second drying device 6A achieves the same operational effects relating to the drying of the ink as the operational effects of the first drying device 4A relating to the drying of the treatment liquid.

In the above-described embodiment, the first drying device 4A, 4B, 4C and 4D, and the second drying device 6A, 6B, 6C, 6D, 6E, and 6F are an example of the “drying device” of the present disclosure. The platen 10 is an example of the “platen” of the present disclosure. The space 40 is an example of the “internal space” of the present disclosure. The passage opening 412 is an example of the “opening” of the present disclosure. The housing 41 is an example of the “housing” of the present disclosure. The heater 44 is an example of the “heater” of the present disclosure. The fan 45 is an example of the “fan” of the present disclosure. The CPU 141 is an example of the “processor” and “computer” of the present disclosure. The processing at S42, S44, and S62 is an example of the “switching processing” of the present disclosure.

The target air flow amount is an example of the “air flow amount” of the present disclosure. The adjustment air flow amount is an example of the “first air flow amount” of the present disclosure. The set air flow amount is an example of the “second air flow amount” of the present disclosure. The target temperature is an example of the “heating temperature” of the present disclosure. The adjustment temperature is an example of the “first temperature” of the present disclosure. The set temperature is an example of the “second temperature” of the present disclosure. The plurality of air blowing outlets 439 are an example of the “air blowing outlet” of the present disclosure. The air supply path 43 is an example of the “pipe” of the present disclosure. The conveyance motor 494 is an example of the “conveyor” of the present disclosure. The main path 71 is an example of the “main path” of the present disclosure. The conveyance path 49 is an example of the “branched path” of the present disclosure. The plurality of printers 2A, 2B, 2C, and 2D are an example of the “inkjet printer” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. The above-described embodiment and each of modified examples may be combined with each other insofar as no contradictions arise. Changes made to the first drying device 4A may also be applied to the first drying devices 4B, 4C, and 4D, and, insofar as no contradictions arise, may also be applied to the second drying devices 6A, 6B, 6C, 6D, 6E, and 6F.

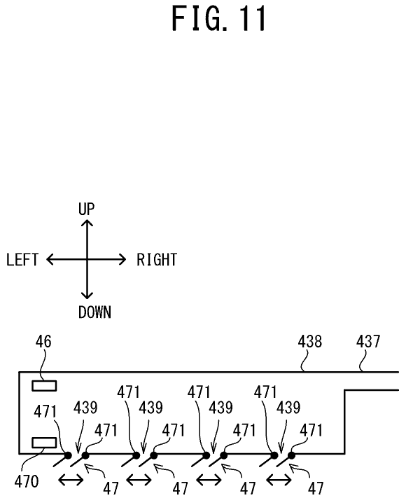

As shown in FIG. 11, louvers 47 may be provided in each of the plurality of air blowing outlets 439. The louver 47 is configured by a pair of vanes. The louver 47 is swingably supported by a pair of axes 471. The pair of axes 471 are positioned at the left end and the right end of the air blowing outlet 439, respectively, and extend in the front-rear direction. Each of the plurality of louvers 47 is connected to a louver motor 470 via a transmission mechanism. The louver motor 470 swings the plurality of louvers 47 in the left-right direction via the transmission mechanism. In this case, in the drying operation by the processing at S34 and S54, the CPU 141 may control the louver motor 470 and swing the plurality of louvers 47 in the left-right direction. During the swinging of the plurality of louvers 47, the CPU 141 may stop the platen 10, or may convey the platen 10 in the left-right direction in the reciprocating manner.

According to the configuration of the above-described plurality of louvers 47, a blowing direction of the heated air from the plurality of air blowing outlets 439 is changed by the plurality of louvers 47, and thus, the temperature distribution of the air in the space 40 is more likely to be uniform. Thus, the first drying device 4A contributes to suppressing the occurrence of unevenness in the progress of the evaporation of the moisture content in the treatment liquid on the medium M.

Furthermore, the direction in which the plurality of louvers 47 swing is the left-right direction, and this coincides with the direction in which the plurality of air blowing outlets 439 are aligned. As a result, in the left-right direction, the temperature distribution of the air inside the space 40 is more likely to be uniform. Thus, the first drying device 4A contributes to suppressing the occurrence of unevenness in the progress of the evaporation of the moisture content in the treatment liquid on the medium M in the left-right direction.

When the above-described changes are applied to the second drying device 6A, the second drying device 6A contributes to suppressing the occurrence of unevenness in the progress of the evaporation of the moisture content in the ink on the medium M in the left-right direction. Note that the direction in which the plurality of louvers 47 swing may intersect the direction in which the plurality of air blowing outlets 439 are aligned. For example, the louver 47 may swing in the front-rear direction.

Other modified examples will be described. The type of the plurality of printers 2A, 2B, 2C, and 2D is not limited to a particular type. For example, each of the printers 2A, 2B, 2C, and 2D may be an ultraviolet (UV) printer that performs printing while irradiating ultraviolet light onto the medium M, or may be a screen printer that performs screen printing. For example, when the printers 2A, 2B, 2C, and 2D are the UV printer or the screen printer, the medium M may be glass, ceramic, plastic, or the like, and may have a shape including a curved surface. The types of the plurality of printers 2A, 2B, 2C, and 2D may be different from each other. The first drying devices 4A, 4B, 4C, and 4D may have mutually different configurations. The second drying devices 6A, 6B, 6C, 6D, 6E, and 6F may have mutually different configurations, and may have a configuration that differs from that of the first drying devices 4A, 4B, 4C, and 4D.

A number of the plurality of printers 2A, 2B, 2C, and 2D, a number of the application devices 3A, a number of the first drying devices 4A, 4B, 4C, and 4D, a number of the heat press devices 5A and 5B, and a number of the second drying devices 6A, 6B, 6C, 6D, 6E, and 6F, respectively, are not limited to those of the above-described embodiment. For example, the print system 1 may be provided only with the first drying device 4A, of the plurality of first drying devices 4A, 4B, 4C, and 4D. The number of the first drying devices 4A, 4B, 4C, and 4D may be different from the number of the printers 2A, 2B, 2C, and 2D. Furthermore, the print system 1 may omit all of the plurality of heat press devices 5A and 5B. The print system 1 may omit one of the plurality of first drying devices 4A, 4B, 4C, and 4D or the plurality of second drying devices 6A, 6B, 6C, 6D, 6E, and 6F. The print system 1 may omit one of the pre-treatment processing or the post-treatment processing.

In the above-described embodiment, the conveyance path 49 that branches from the main path 71 extends to the space 40. In contrast to this, the conveyance path 49 may be omitted and the first drying device 4A may be disposed on the main path 71. For example, the first drying device 4A may be disposed on the outward path 72 in a state in which the left surface 411 is oriented to the front of the print system 1. In this case, the passage opening 412 becomes an entrance of the platen 10 into the housing 41, and thus, for example, the surface on the opposite side from the left surface 411 of the housing 41 becomes an exit port of the platen 10 from the housing 41. The main path 71 may be configured as a one-level structure, and need not necessarily be cyclical.

In the above-described embodiment, the plurality of air blowing outlets 439 are aligned in the front-rear direction, but may be aligned in a lattice shape, or in a zig-zag shape. The air blowing chamber 438 may be provided with the single air blowing outlet 439. In the left-right direction, the distance D between the first housed position P31 and the second housed position P32 may be the same as the interval S, or may be smaller than the interval S. In a period from when the drying operation is started to when the drying operation is stopped, the CPU 141 may convey the platen 10 in one direction, from one of the first housed position P31 or the second housed position P32 to the other. In the drying operation, the CPU 141 may stop the platen 10, or may rotate the platen 10 in the clockwise direction or the counterclockwise direction in a plan view.

In the above-described embodiment, the second switching timing T2 is reached after the first switching timing T1 is reached. In contrast to this, the second switching timing T2 may be reached before the first switching timing T1 is reached. In other words, the CPU 141 may switch the target temperature from the adjustment temperature to the set temperature before switching the target air flow amount from the adjustment air flow amount to the set air flow amount.

In the above-described embodiment, the first switching timing T1, the second switching timing T2, and the end timing T3 are set based on the application amount of the treatment liquid. In contrast to this, some or all of the first switching timing T1, the second switching timing T2, and the end timing T3 may be set based on another parameter in place of or in addition to the application amount of the treatment liquid. The other parameter may be the type of the treatment liquid, the type of the ink, the type of the medium M, and the like, for example. Some or all of the first switching timing T1, the second switching timing T2, and the end timing T3 may be established in advance, irrespective of the application amount of the treatment liquid or the like.

In the above-described embodiment, the adjustment temperature is higher than the set temperature. In contrast to this, the adjustment temperature may be lower than the set temperature. In the above-described embodiment, the adjustment air flow amount is smaller than the set air flow amount. In contrast to this, the adjustment air flow amount may be greater than the set air flow amount.

In the above-described embodiment, the set air flow amount and the set temperature are each set by the user. In contrast to this, a configuration may be adopted in which one or both of the set air flow amount and the set temperature cannot be set by the user. In other words, for example, a configuration may be adopted in which both the set air flow amount and the adjustment air flow amount are set to different and fixed values.

In the above-described embodiment, the CPU 141 may omit the determination at S25. In other words, the CPU 141 may execute one of each of the processing steps from S31 to S46, or each of the processing steps from S51 to S64, irrespective of the application pattern.

In the above-described embodiment, in the case of the entire application, the CPU 141 controls both the heater 44 and the fan 45 in the housed state, and switches the target air flow amount and the target temperature. In the case of the partial application, the CPU 141 controls the fan 45 in the housed state and switches the target air flow amount, without switching the target temperature. In contrast to this, the CPU 141 may control the heater 44 in the housed state and may switch the target temperature, without switching the target air flow amount. For example, in each of the processing steps from S31 to S46, the CPU 141 may omit the determination at S41 and the processing at S42.

A number of times that the air supply state is switched is not limited to the one or two times of the above-described embodiment, and may be three times or more. For example, in the above-described embodiment, after the second switching timing T2 and before the end timing T3, the CPU 141 may switch the target temperature from the set temperature to the adjustment temperature of the above-described embodiment, or may switch to another adjustment temperature. The other adjustment temperature is a temperature that differs from the adjustment temperature of the above-described embodiment. The other adjustment temperature may be higher than the set temperature or may be lower than the set temperature. For example, after the start timing TO and before the second switching timing T2, the CPU 141 may switch the target temperature from the adjustment temperature of the above-described embodiment to the other adjustment temperature. The target air flow amount may also be changed in a similar manner to the target temperature.

In the above-described embodiment, the CPU 141 sets each of the first switching timing T1, the second switching timing T2, and the end timing T3 based on the first setting table 145, for example. In contrast to this, the CPU 141 may calculate each of the first switching timing T1, the second switching timing T2, and the end timing T3 based on the application amount of the treatment liquid, for example, and may set the calculated values.

In the above-described embodiment, an encoder may be provided in the conveyance motor 494, in place of the first position sensor 481 and the second position sensor 482. The CPU 141 may identify the position of the platen 10 based on a detection signal from the encoder.

In the above-described embodiment, in the determination at S21, the CPU 141 determines whether the platen 10 has been transferred from the transfer mechanism 82 to the conveyance path 49 based on whether the transfer notification has been received from the conveyance device 7. In contrast to this, a sensor may be provided at a position at which the platen 10 is transferred from the transfer mechanism 82 to the conveyance path 49, and the CPU 141 may determine that the platen 10 has been transferred from the transfer mechanism 82 to the conveyance path 49 based on a detection signal from the sensor.

In the above-described embodiment, the CPU 141 may control not only the first drying device 4A, but also some or all of the other devices in the print system 1. The CPU 141 may be disposed at a position separated from the first drying device 4A. The control portion of the conveyance device 7 may control the conveyance motor 494.

The shape of the housing 41 is not limited to that of the above-described embodiment. For example, the exhaust outlet 413 need not necessarily be provided in the housing 41. The shape of the air supply path 43 is also not limited to that of the above-described embodiment. For example, the positional relationship of the heating chamber 434 and the air supply chamber 436 may be reversed. For example, the air supply path 43 may omit one or both of the outside air introduction path 431 and the connecting path 432. The first drying device 4A may omit the air supply path 43. In this case, the heater 44 and the fan 45 are respectively disposed in the space 40.

In the above-described embodiment, the platen 10 on which is placed the medium M to which the treatment liquid has been applied is conveyed to the first drying device 4A, and the platen 10 on which is placed the medium M to which the ink has been applied is conveyed to the second drying device 6A. In contrast to this, both the platen 10 on which is placed the medium M to which the treatment liquid has been applied and the platen 10 on which is placed the medium M to which the ink has been applied may be conveyed to the first drying device 4A, for example.

In place of the CPU 141, a microcomputer, application specific integrated circuits (ASICs), a field programmable gate array (FPGA) or the like may be used as a processor. The first drying processing may be performed as distributed processing by a plurality of the processors. It is sufficient that the non-transitory storage media, such as the ROM 142, the flash memory 144, and the like be a storage medium capable of storing information, regardless of a period of storing the information. The non-transitory storage medium need not necessarily include a transitory storage medium (a transmitted signal, for example). The control program may be downloaded from a server connected to a network (not shown in the drawings) (in other words, may be transmitted as transmission signals), and may be stored in the ROM 142 or the flash memory 144. In this case, the control program may be stored in a non-transitory storage medium, such as an HDD provided in the server.

What is claimed is:

1. A drying device comprising:
a housing including an internal space and an opening, the internal space being configured to house a platen, a medium to which an ink or a treatment liquid is applied being configured to be placed on the platen, the opening being connected to the internal space and being of a size through which the platen passes;
a heater configured to heat air;
a fan configured to supply heated air to the internal space, the heated air being air heated by the heater;
a processor; and
a memory storing computer-readable instructions that, when executed by the processor, instruct the processor to perform a process comprising:
switching, in a housed state of the platen being housed in the internal space, an air supply state of the heated air supplied by the fan from a first air supply state to a second air supply state different from the first air supply state by controlling at least one of the heater or the fan.

2. The drying device according to claim 1, wherein
the computer-readable instructions instruct the processor to perform a process comprising:
switching the air supply state from the first air supply state to the second air supply state by controlling the fan and switching an air flow amount by the fan from a first air flow amount to a second air flow amount different from the first air flow amount.

3. The drying device according to claim 2, wherein
the computer-readable instructions instruct the processor to perform a process comprising:
switching the air flow amount from the first air flow amount to the second air flow amount that is greater than the first air flow amount.

4. The drying device according to claim 1, wherein
the computer-readable instructions instruct the processor to perform a process comprising:
switching the air supply state from the first air supply state to the second air supply state by controlling the heater and switching a heating temperature by the heater from a first temperature to a second temperature different from the first temperature.

5. The drying device according to claim 4, wherein
the computer-readable instructions instruct the processor to perform a process comprising:
switching the heating temperature from the first temperature to the second temperature that is lower than the first temperature.

6. The drying device according to claim 1, wherein
the computer-readable instructions instruct the processor to perform processes comprising:
acquiring an application amount of the ink or of the treatment liquid onto the medium, and
switching the air supply state from the first air supply state to the second air supply state based on the acquired application amount.

7. The drying device according to claim 1, wherein
the computer-readable instructions instruct the processor to perform processes comprising:
switching, when a first switching timing is reached, the air supply state from the first air supply state to the second air supply state by controlling the fan and switching an air flow amount by the fan from a first air flow amount to a second air flow amount different from the first air flow amount, and
switching, when a second switching timing subsequent to the first switching timing is reached, the air supply state from the second air supply state to a third air supply state different from the second air supply state by controlling the heater and switching a heating temperature by the heater from a first temperature to a second temperature different from the first temperature.

8. The drying device according to claim 1, further comprising:
a pipe connecting the fan and an air blowing outlet to each other, the air blowing outlet being open toward the internal space and configured to blow the heated air supplied by the fan into the internal space; and
a louver swingably provided at the air blowing outlet, wherein
the computer-readable instructions instruct the processor to perform a process comprising:
swing the louver in the housed state.

9. The drying device according to claim 8, wherein
the air blowing outlet includes a plurality of air blowing outlets aligned in a specific direction,
the pipe is connected to each of the plurality of air blowing outlets,
the louver includes a plurality of louvers provided at each of the plurality of air blowing outlets, and
the computer-readable instructions instruct the processor to perform a process comprising:
swing the plurality of louvers in the specific direction.

10. The drying device according to claim 1, wherein
the computer-readable instructions instruct the processor to perform a process comprising:
conveying the platen in a reciprocating manner in the internal space by controlling a conveyor in the housed state, the conveyor being configured to convey the platen in the internal space.

11. The drying device according to claim 1, further comprising:
a pipe connecting the fan and a plurality of air blowing outlets to each other, each of the plurality of air blowing outlets being open toward the internal space and being configured to blow the heated air supplied by the fan into the internal space, wherein
the plurality of air blowing outlets are aligned in a conveyance direction of a conveyor, the conveyor being configured to convey the platen in the internal space, and
the computer-readable instructions instruct the processor to perform a process comprising:
conveying the platen in the conveyance direction by a distance greater than an interval between a pair of the air blowing outlets adjacent to each other, of the plurality of air blowing outlets by controlling the conveyor in the housed state.

12. The drying device according to claim 10, wherein
the platen is configured to be conveyed along a main path,
a branched path is branched from the main path and extends to the internal space,
the platen on which the medium is placed before or after the ink is discharged thereon by an inkjet printer, is conveyed from the main path to the housing via the branched path, and
the computer-readable instructions instruct the processor to perform a process comprising:
conveying the platen in a reciprocating manner on the branched path by controlling the conveyor in the housed state.

13. A drying control method comprising:
a switching processing of switching an air supply state of heated air from a first air supply state to a second air supply state different from the first air supply state by controlling at least one of a heater or a fan in a housed state of a platen being housed in a internal space, a medium to which an ink or a treatment liquid is applied being configured to be placed on the platen, the internal space being a space provided inside a housing and being connected to an opening, the opening being provided at the housing and being of a size through which the platen passes, the heater being configured to heat air, the heated air being air heated by the heater, the fan being configured to supply the heated air to the internal space.

14. A non-transitory computer-readable medium storing computer-readable instructions that, when executed by a computer, instruct the computer to perform a process comprising:
a switching processing of switching an air supply state of heated air from a first air supply state to a second air supply state different from the first air supply state by controlling at least one of a heater or a fan in a housed state of a platen being housed in a internal space, a medium to which an ink or a treatment liquid is applied being configured to be placed on the platen, the internal space being a space provided inside a housing and being connected to an opening, the opening being provided at the housing and being of a size through which the platen passes, the heater being configured to heat air, the heated air being air heated by the heater, the fan being configured to supply the heated air to the internal space.
